(19) United States
(12) Patent Application Publication
(10) Pub. No.: US 2024/0289249 A1
(43) Pub. Date: Aug. 29, 2024

(54) METHOD AND SYSTEM FOR TESTING AUTOMATION IN MARKETPLACE

(71) Applicants: Rakuten Mobile, Inc., Tokyo (JP); Rakuten Symphony India Private Limited, Indore, MP (IN)

(72) Inventors: Farnaz SALEHI, Tokyo (JP); Ramachandran PADMANABHA RAO, Indore (IN)

(73) Assignees: Rakuten Mobile, Inc., Tokyo (JP); Rakuten Symphony India Private Limited, Indore (IN)

(21) Appl. No.: 18/012,750

(22) PCT Filed: Oct. 27, 2022
(86) PCT No.: PCT/US2022/048045

§ 371 Date: Dec. 23, 2022

(51) Int. Cl. G06F 11/36

(52) U.S. Cl. CPC G06F 11/36

(57) ABSTRACT

Provided are system, method, and device for managing a testing in a marketplace. The system includes: a first module including: a memory storage storing computer-executable instructions; and a processor communicatively coupled to the memory storage, wherein the processor may be configured to execute the computer-executable instructions and cause the first module to: present, to a user, information of one or more testing associated to a service, wherein the one or more testing comprise at least one mandatory testing and at least one optional testing; receive, from the user, a selection for the one or more testing; collect testing information associated with the user's selection; and output the collected testing information.

### CROSS REFERENCE TO RELATED APPLICATIONS

This application is based on and claims the benefit of Provisional Patent Application No. 20/224,1049596, filed with the Indian Patent Office on Aug. 30, 2022 and entitled “METHOD AND SYSTEM FOR AUTOMATION AND ROLE-BASED CONTROL IN MARKETPLACE”, the disclosure of which is incorporated herein by reference in its entirety.

### TECHNICAL FIELD

Methods and systems consistent with example embodiments of the present disclosure relate to a marketplace, more particularly, related to automation in one or more testing in the marketplace.

### BACKGROUND

Traditionally, telecommunication systems have been mainly hardware-based, and telecommunication services were mainly provided in the form of hardware and were usually proprietary or managed by a specific vendor, a service provider, and/or a network operator. Recently, the evolvement of telecommunication technologies enables the telecommunication services to be provided in the form of software. For instance, the telecommunication network services can be defined and provided in software-based form or virtual network services, such as Virtualized Network Functions (VNFs) or Software Defined Networking (SDN), among others.

Accordingly, telecommunication services may be deployed and be provided via a software-based marketplace system, along with other non-telecommunication services (e.g., enterprise software, business supporting applications, etc.). Although providing services via a marketplace provides various advantages, such as allowing a telecommunication service to be integrated with and be operated along with a non-telecommunication service to thereby provide unique user experience and extended functionality, it is required to further improve the end-to-end processes of services in the marketplace.

Specifically, handling end-to-end processes such as (but are not limited to) publishing, deploying, and operating products or services is one of the most complex and tedious processes in the marketplace. At the first place, the related art does not provide end-to-end solutions for integrating and managing end-to-end processes of products or services in the marketplace.

Further, disaggregation in services provision and services management (i.e., service provision and management may no longer proprietary or managed by a limited number of users) in the marketplace significantly increases the number of users (e.g., network operators, vendors, service providers, customers, etc.), each of which may use the marketplace for different purposes and may have different levels of requirements on the services. Accordingly, the marketplace in the related art may be highly fragmented, where different users (e.g., network operators, marketplace managers, etc.) require different information levels and formats from other users (e.g., vendors, service providers, developers, etc.) in order to onboard and manage services. It is a challenging task for all users to meet the information and service requirements.

Among others, testing processes in the end-to-end processes may be particularly difficult to be managed and be provided in an efficient and effective manner. Specifically, various testing may be required throughout the end-to-end processes, but the testing processes in the related art marketplace are time-consuming, inefficient, and burdensome for the users.

Firstly, the related art does not provide any feature to allow a user to quickly and effectively set up or configure a testing. Specifically, whenever a testing for a service is required, the vendor, developer, service provider, or any other suitable personnel which associated with the service (referred to as “testing requestor” hereinafter) may be required to manually contact the personnel who will be managing or performing the testing (referring to as “testing party” hereinafter)to discuss about the testing. For instance, whenever the testing requestor want to on-board a service to the marketplace, the service may need to be tested by testing party such as a system admin (e.g., network operator, marketplace manager, etc.) to ensure that the service complies to the system's minimal requirement (e.g., functionality, security, etc.). Subsequently, if the testing requestor would like to integrate the service with another service in the marketplace, the testing requestor may need to contact another testing party such as the owner or manager of said another service to arrange an integration test.

To this end, in the marketplace of related art, whenever one or more testing are required, the testing requestor may be required to contact each of the testing parties individually or separately through, for example, sending an email, making a telephone call, creating a ticket (via JIRA® or any other suitable ticket management system), or the like. Namely, multiple to-and-fro communications may be required until a testing may actually be performed. The processes of setting up or configuring one or more testing may be time consuming, inefficient, and burdensome for the testing requestor and/or the testing party, particularly when the testing requestor and/or the testing party is inexperienced (e.g., the testing requestor may be unfamiliar with the testing processes, the testing party may be unclear on how to set up the a specific testing, etc.) and/or is managing a significant amount of services or testing at the same time.

On the other hand, the related art also does not provide any feature for efficiently or effectively setting up or configuring a testing(s). Specifically, the testing party may receive a significant number of requests (from one or more requestors), each of which may have specific testing requirements. Subsequently, the testing party may need to manually review each of the requests, to contact the requestor for discussion if required, and then set up a customized testing for said requestor thereafter. Thus, it will be burdensome for the testing party to response to the testing requests, which may in turns result in long turnaround time for responding to the testing requests, thereby delaying the testing and affect the deployment of the associated service(s).

Furthermore, the related art also does not provide effective and efficient testing information management (particularly, testing status management and testing results management) to the testing requestor and the testing party.

Specifically, in the marketplace of related art, upon sending a testing request, the requestor may need to closely monitor the status of the requested testing. In this regards, if the requestor has sent multiple testing requests to multiple testing parties (e.g., X requests were sent to the system admin, Y requests were sent to manager of service B, etc.), the requestor may need to first create new requests for status updates for each of the testing requests (which may further increase the burden of the requestor and the testing parties in managing the requests, such as managing multiple correspondences or tickets, etc.), and may then need to simultaneously take note of statuses or records of the requests and/or testing on different channels (e.g., system admin may provide status update via commenting on the associated tickets, manager of service B may provide status update in multiple emails, etc.). Further, the testing parties may provide the information of the testing statuses in different manner (e.g., system admin may use system A to generate and provide testing status information in format A, manager of service B may use system B to generate and provide testing information in format B, etc.), which may increase the difficulty for the requestor to quickly grasp the testing statuses. Accordingly, it may be difficult for the requestor to quickly obtain a comprehensive view on the testing statuses, and the requestor may overlook one or more of status updates, which may in turns result in inefficient communication with the testing parties and may cause delay in service deployment.

Similarly, the marketplace of the related art also does not provide effective and efficient way in producing and managing testing reports or logs. Specifically, whenever a requestor want to obtain a testing report(s) or log(s), the requestor may need to again create new one or more requests for the same. Further, the requestor may need to manage testing reports or logs provided by different personnel, which may be in different formats. Furthermore, since the testing report(s) or log(s) are generated by the testing party (i.e., the requestor has no control in the content of the testing report or log by default), the provided testing report(s) or log(s) may contains too much detailed information some of which are not of the requestor's interest, or may contains too less information which do not include the requestor's intended information. As a result, the requestor may further request the testing parties to provide customized testing report(s) or log(s), and the testing parties may receive significant amount of requests for customization of the same, which may further increase the burden of the testing parties.

### SUMMARY

According to embodiments, systems, methods, and devices are provided for efficiently and effectively setting up or configuring one or more testing for a user. Specifically, example embodiments allow the user to configure or customize one or more testing at user end as per requirement, and the one or more customized testing may be automatically performed. Thus, multiple to-and-fro communications among multiple parties in configuring a testing in the related art may be eliminated, and the associated processes may be simplified. Accordingly, example embodiments effectively reduce the burden of the users (e.g., the testing requestor and the testing party), improve the efficiency in process of testing customization, and simplify the process of testing execution.

Further, according to embodiments, systems, methods, and devices are provided for efficiently and effectively managing testing information such as testing status and/or testing result. Specifically, the system and method of the example embodiments automatically generate and provide the testing status and/or testing results to the user as per request, such as provide the testing status and/or testing results in real-time or near real-time and provide the testing status and/or testing results associated with multiple testing in a converged manner, without the involvement of the testing party. Accordingly, the testing status and/or testing results can be provided in a timely and effective manner.

According to embodiments, a system includes: a first module including: a memory storage storing computer-executable instructions; and a processor communicatively coupled to the memory storage, wherein the processor may be configured to execute the computer-executable instructions and cause the first module to: present, to a user, information of one or more testing associated to a service, wherein the one or more testing may include at least one mandatory testing and at least one optional testing; receive, from the user, a selection for the one or more testing; collect testing information associated with the user's selection; and output the collected testing information.

The processor of the first module may be configured to execute the computer-executable instructions and cause the first module to generate a graphical user interface (GUI) and to present the information of the one or more testing via the GUI.

The GUI may include one or more interactive elements which are associated with the one or more testing, and the processor of the first module may be configured to execute the computer-executable instructions and cause the first module to receive the user's selection by determining one or more user's interaction on the one or more interactive elements.

The one or more interactive elements may be associated with a testing profile ID, and the processor of the first module may be configured to execute the computer-executable instructions and cause the first module to collect the testing information associated with the user's selection by collecting testing profile ID of user's selected testing.

The system may further include: a second module including: a memory storage storing computer-executable instructions; and a processor communicatively coupled to the memory storage, wherein the processor may be configured to execute the computer-executable instructions and cause the second module to: receive, from the first module, the collected testing information; generate, based on the collected testing information, a testing scheme; and output the generated testing scheme.

The system may further include a third module including: a memory storage storing computer-executable instructions; and a processor communicatively coupled to the memory storage, wherein the processor may be configured to execute the computer-executable instructions and cause the third module to: receive, from the second module, the generated testing scheme; execute, based on the testing scheme, the one or more testing selected by the user; and store information associated with the testing.

The system may further include a fourth module including: a memory storage storing computer-executable instructions; and a processor communicatively coupled to the memory storage, wherein the processor may be configured to execute the computer-executable instructions and cause the fourth module to: receive, from the third module, the information associated with the testing; store the received information; and provide the stored information to the first module.

According to embodiments, a method, which may be performed by at least one processor, including: presenting, by a first module, information of one or more testing associated to a service to a user, wherein the one or more testing comprise at least one mandatory testing and at least one optional testing; receiving, by the first module, a selection for the one or more testing from the user; collecting, by the first module, testing information associated with the user's selection; and outputting, by the first module, the collected testing information.

The presenting of the information of the one or more testing may include: generating, by the first module, a graphical user interface (GUI); and presenting, by the first module, the information of the one or more testing via the GUI.

The GUI may include one or more interactive elements which are associated with the one or more testing, and the receiving of the user's selection may include determining, by the first module, one or more user's interaction on the one or more interactive elements.

The one or more interactive elements may be associated with a testing profile ID, and the collecting of the testing information associated with the user's selection may include collecting, by the first module, testing profile ID of user's selected testing.

The method may further include: receiving, by a second module, the collected testing information from the first module; generating, by the second module, a testing scheme based on the collected testing information; and outputting, by the second module, the generated testing scheme.

The method may further include: receiving, by a third module, the generated testing scheme from the second module; executing, by the third module, the one or more testing selected by the user based on the testing scheme; and storing, by the third module, information associated with the testing.

The method may further include: receiving, by a fourth module, the information associated with the testing from the third module; storing, by the fourth module, the received information; and providing, by the fourth module, the stored information to the first module.

According to embodiments, a non-transitory computer-readable recording medium having recorded thereon instructions executable by a processor to cause the processor to perform a method including: presenting, by a first module, information of one or more testing associated to a service to a user, wherein the one or more testing comprise at least one mandatory testing and at least one optional testing; receiving, by the first module, a selection for the one or more testing from the user; collecting, by the first module, testing information associated with the user's selection; and outputting, by the first module, the collected testing information.

The presenting of the information of the one or more testing may include: generating, by the first module, a graphical user interface (GUI); and presenting, by the first module, the information of the one or more testing via the GUI.

The GUI may include one or more interactive elements which are associated with the one or more testing, and the receiving of the user's selection may include determining, by the first module, one or more user's interaction on the one or more interactive elements.

The one or more interactive elements may be associated with a testing profile ID, and the collecting of the testing information associated with the user's selection may include collecting, by the first module, testing profile ID of user's selected testing.

The method may further include: receiving, by a second module, the collected testing information from the first module; generating, by the second module, a testing scheme based on the collected testing information; and outputting, by the second module, the generated testing scheme.

The method may further include: receiving, by a third module, the generated testing scheme from the second module; executing, by the third module, the one or more testing selected by the user based on the testing scheme; and storing, by the third module, information associated with the testing.

The method may further include: receiving, by a fourth module, the information associated with the testing from the third module; storing, by the fourth module, the received information; and providing, by the fourth module, the stored information to the first module.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like reference numerals denote like elements, and wherein:

FIG. 1 illustrates a diagram of a general system architecture, according to one or more embodiments;

FIG. 2 illustrates a diagram of the centralized marketplace, according to one or more embodiments;

FIG. 3 illustrates an example of system modules for managing one or more testing, according to one or more embodiments;

FIG. 4 illustrates an example block diagram of system modules for managing one or more end-to-end processes, according to one or more embodiments;

FIG. 5 illustrates an example block diagram of a system for managing end-to-end testing, according to one or more embodiments;

FIG. 6 illustrates a generalized GUI of a testing workspace, according to one or more embodiments;

FIG. 7 illustrates an example of GUI of the testing workspace, according to one or more embodiments;

FIG. 8 illustrates an example of another generalized GUI of the testing workspace, according to one or more embodiments;

FIG. 9 illustrates an example of yet another generalized GUI of the testing workspace, according to one or more embodiments;

FIG. 10 illustrates an example flow diagram of a method for interacting with a user to configure one or more testing, according to one or more embodiments;

FIG. 11 illustrates an example flow diagram of a method for generating a testing scheme, according to one or more embodiments;

FIG. 12 illustrates an example flow diagram of a method for managing one or more testing, according to one or more embodiments;

FIG. 13 is a diagram of an example environment in which systems and/or methods, described herein, may be implemented; and

FIG. 14 is a diagram of example components of a device, according to one or more embodiments.

### DETAILED DESCRIPTION

The following detailed description of exemplary embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

In one implementation of the disclosure described herein, a display page may include information residing in the computing device's memory, which may be transmitted from the computing device over a network to a database center and vice versa. The information may be stored in memory at each of the computing device, a data storage resided at the edge of the network, or on the servers at the database centers. A computing device or mobile device may receive non-transitory computer readable media, which may contain instructions, logic, data, or code that may be stored in persistent or temporary memory of the mobile device, or may somehow affect or initiate action by a mobile device. Similarly, one or more servers may communicate with one or more mobile devices across a network, and may transmit computer files residing in memory. The network, for example, can include the Internet, wireless communication network, or any other network for connecting one or more mobile devices to one or more servers.

Any discussion of a computing or mobile device may also apply to any type of networked device, including but not limited to mobile devices and phones such as cellular phones (e.g., any “smart phone”), a personal computer, server computer, or laptop computer; personal digital assistants (PDAs); a roaming device, such as a network-connected roaming device; a wireless device such as a wireless email device or other device capable of communicating wireless with a computer network; or any other type of network device that may communicate over a network and handle electronic transactions. Any discussion of any mobile device mentioned may also apply to other devices, such as devices including short-range ultra-high frequency (UHF) device, near-field communication (NFC), infrared (IR), and Wi-Fi functionality, among others.

Phrases and terms similar to “software”, “application”, “app”, and “firmware” may include any non-transitory computer readable medium storing thereon a program, which when executed by a computer, causes the computer to perform a method, function, or control operation.

Phrases and terms similar to “network” may include one or more data links that enable the transport of electronic data between computer systems and/or modules. When information is transferred or provided over a network or another communications connection (either hardwired, wireless, or a combination of hardwired or wireless) to a computer, the computer uses that connection as a computer-readable medium. Thus, by way of example, and not limitation, computer-readable media can also include a network or data links which can be used to carry or store desired program code means in the form of computer-executable instructions or data structures and which can be accessed by a general purpose or special purpose computer.

Phrases and terms similar to “portal” or “terminal” may include an intranet page, internet page, locally residing software or application, mobile device graphical user interface, or digital presentation for a user. The portal may also be any graphical user interface for accessing various modules, components, features, options, and/or attributes of the disclosure described herein. For example, the portal can be a web page accessed with a web browser, mobile device application, or any application or software residing on a computing device.

Phrases and terms similar to “marketplace”, “marketplace platform”, “marketplace system”, or “marketplace module” may refer to a system through which a plurality of users may provide, receive, and/or utilize one or more services.

Phrases and terms similar to “testing party” may include any suitable personnel who can configure or manage a testing of a service, such as: system admin which may include a user from a network operator, a user managing the marketplace, an owner of a service, and the like. On the other hand, phrases and terms similar to “testing requestor” may include any suitable personnel who can request for a testing of a service, such as: a vendor, a developer, a service provider, an owner of a service, and the like

Phrases and terms similar to “products” or “services” may include a product, a service, an application, which may be virtualized/defined in software-form and may be deployed via the marketplace. Further, while example embodiments may refer to telecommunications related products and services, it is understood that the disclosure is not limited thereto and the marketplace may be for telecommunications and/or non-telecommunications related products. For example, the marketplace may provide applications and services for business enterprises in general (e.g., customer service-related applications, inventory management applications, financial forecasting or planning applications, accounting applications, etc.).

Example embodiments of the present disclosure provide a system and method that efficiently and effectively setting up or configuring one or more testing for a user. Specifically the system and method of the example embodiments allow the user to configure or customize one or more testing at user end as per requirement, and the one or more customized testing may be automatically performed. Thus, multiple to-and-fro communications among multiple parties in configuring a testing in the related art may be eliminated, and the associated processes may be simplified. Accordingly example embodiments of the present disclosure effectively reduce the burden of the users (e.g., the testing requestor and the testing party), improve the efficiency in process of testing customization, and simplify the process of testing execution.

Further, example embodiments of the present disclosures provide a system and method that efficiently and effectively manage testing information such as testing status and/or testing result/log. Specifically, the system and method of the example embodiments automatically generate and provide the testing status and/or testing result to the user as per request, such as provide the testing status and/or testing results in real-time or near real-time and provide the testing status and/or testing results associated with multiple testing in a converged manner, without the involvement of the testing party. Accordingly, the testing status and/or testing results can be provided in a timely and effective manner.

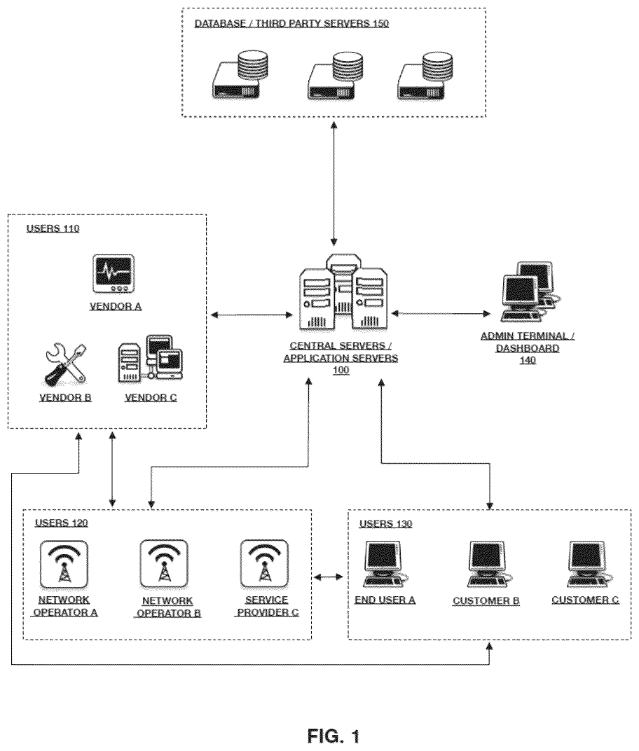

FIG. 1 illustrates a diagram of an example general network architecture, according to one or more embodiments. Referring to FIG. 1, users 110, 120, and 130 can be in bi-directional communication over a secure network with central servers or application servers 100 according to one or more embodiments. In addition, users 110, 120, 130 may also be in direct bi-directional communication with each other via the marketplace platform network system according to one or more embodiments. Here, users 110 can be any type of vendor, service provider, or developer, such as vendors A, B, and C, offering to either users 120 or users 130 similar, same, or different services or products with respect to a network or service operator. In particular, users 110 can provide any type of telecommunication and/or non-telecommunication service or product, such as cellular service network deployment, network capacity update, operational monitoring, data analytics and reporting, performance analysis, and any other suitable services. Each of users 110 can communicate with servers 100 via their respective terminals or portals. Users 120 can be network operators A and B and service provider C, which may offer similar, same, or different services or products to users 130 or users 110. Here, users 110 or 120 can be any type of vendor or network service provider, network operator, carrier, broadband provider, Unified Communications as a Service (UCaaS) providers, wired or wireless cellular network service provider, radio access network (RAN), web host, or any network or telecommunications related service or network provider, among others. Each of users 120 can communicate with servers 100 via their respective terminals or portals. Users 130 can be any type of end user or customer of users 120 or users 110, such as end user A or customers B and C, or the end user purchasing and/or receiving the services of users 110 or users 120. Each of users 130 can communicate with servers 100 via their respective terminals or portals.

Still referring to FIG. 1, central servers 100 of the marketplace platform system according to one or more embodiments can be in further bi-directional communication with admin terminal/dashboard 140. Here, admin terminal/dashboard 140 can provide various tools to any of users 110, 120, and 130, or a sales team or a content/product creation team to manage various customers/end users and customer leads, wherein such managing can include, among others, creating, editing, and promoting various types of services or product sales promotional campaigns, advertising, offerings, and ordering options for customers and other users of the marketplace platform according to one or more embodiments. In addition, admin terminal/dashboard 140 may also include various types of access privileges to different users of the marketplace platform system according to one or more embodiments. Further, central servers 100 according to one or more embodiments can be in further bi-directional communication with database/third party servers 150. Here, servers 150 can provide various types of data storage (such as cloud-based storage), web services, content creation tools, data streams, data feeds, and/or provide various types of third-party support services to central servers 100 of the marketplace platform. However, it is contemplated within the scope of the present disclosure described herein that the network services marketplace platform process and system according to one or more embodiments can include any type of general network architecture.

Still referring to FIG. 1, one or more servers or terminals of elements 100-150 may include a personal computer (PC), a printed circuit board comprising a computing device, a mini-computer, a mainframe computer, a microcomputer, a telephonic computing device, a wired/wireless computing device (e.g., a smartphone, a personal digital assistant (PDA)), a laptop, a tablet, a smart device, a wearable device, or any other similar functioning device.

In some embodiments, as shown in FIG. 1, one or more servers, terminals, and users 100-150 may include a set of components, such as a processor, a memory, a storage component, an input component, an output component, a communication interface, and a JSON UI rendering component. The set of components of the device may be communicatively coupled via a bus.

The bus may comprise one or more components that permit communication among the set of components of one or more of servers or terminals of elements 100-150. For example, the bus may be a communication bus, a cross-over bar, a network, or the like. The bus may be implemented using single or multiple (two or more) connections between the set of components of one or more of servers or terminals of elements 100-150. The disclosure is not limited in this regard.

One or more servers or terminals of elements 100-150 may comprise one or more processors. The one or more processors may be implemented in hardware, firmware, and/or a combination of hardware and software. For example, the one or more processors may comprise a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), a general purpose single-chip or multi-chip processor, or other programmable logic device, discrete gate or transistor logic, discrete hardware components, or any combination thereof designed to perform the functions described herein. A general purpose processor may be a microprocessor, or any conventional processor, controller, microcontroller, or state machine. The one or more processors also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The one or more processors may control overall operation of one or more of servers or terminals of elements 100-150 and/or of the set of components of one or more of servers or terminals of elements 100-150 (e.g., memory, storage component, input component, output component, communication interface, rendering component).

One or more of servers or terminals of elements 100-150 may further comprise memory. In some embodiments, the memory may comprise a random access memory (RAM), a read only memory (ROM), an electrically erasable programmable ROM (EEPROM), a flash memory, a magnetic memory, an optical memory, and/or another type of dynamic or static storage device. The memory may store information and/or instructions for use (e.g., execution) by the processor.

A storage component of one or more of servers or terminals of elements 100-150 may store information and/or computer-readable instructions and/or code related to the operation and use of one or more of servers or terminals of elements 100-150. For example, the storage component may include a hard disk (e.g., a magnetic disk, an optical disk, a magneto-optic disk, and/or a solid state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

One or more of servers or terminals of elements 100-150 may further comprise an input component. The input component may include one or more components that permit one or more of servers and terminals 110-140 to receive information, such as via user input (e.g., a touch screen, a keyboard, a keypad, a mouse, a stylus, a button, a switch, a microphone, a camera, and the like). Alternatively or additionally, the input component may include a sensor for sensing information (e.g., a global positioning system (GPS) component, an accelerometer, a gyroscope, an actuator, and the like).

An output component any one or more of servers or terminals of elements 100-150 may include one or more components that may provide output information from the device 100 (e.g., a display, a liquid crystal display (LCD), light-emitting diodes (LEDs), organic light emitting diodes (OLEDs), a haptic feedback device, a speaker, and the like).

One or more of servers or terminals of elements 100-150 may further comprise a communication interface. The communication interface may include a receiver component, a transmitter component, and/or a transceiver component. The communication interface may enable one or more of servers or terminals of elements 100-150 to establish connections and/or transfer communications with other devices (e.g., a server, another device). The communications may be enabled via a wired connection, a wireless connection, or a combination of wired and wireless connections. The communication interface may permit one or more of servers or terminals of elements 100-150 to receive information from another device and/or provide information to another device. In some embodiments, the communication interface may provide communications with another device via a network, such as a local area network (LAN), a wide area network (WAN), a metropolitan area network (MAN), a private network, an ad hoc network, an intranet, the Internet, a fiber optic-based network, a cellular network (e.g., a fifth generation (5G) network, a long-term evolution (LTE) network, a third generation (3G) network, a code division multiple access (CDMA) network, and the like), a public land mobile network (PLMN), a telephone network (e.g., the Public Switched Telephone Network (PSTN)), or the like, and/or a combination of these or other types of networks. Alternatively or additionally, the communication interface may provide communications with another device via a device-to-device (D2D) communication link, such as FlashLinQ, WiMedia, Bluetooth, ZigBee, Wi-Fi, LTE, 5G, and the like. In other embodiments, the communication interface may include an Ethernet interface, an optical interface, a coaxial interface, an infrared interface, a radio frequency (RF) interface, or the like.

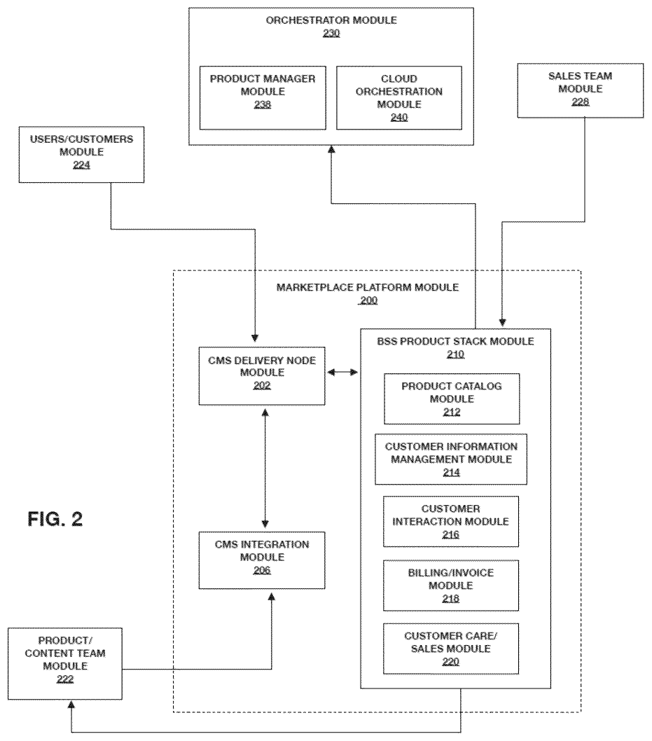

FIG. 2 illustrates an example system of a centralized marketplace platform, according to one or more embodiments. Referring to FIG. 2, marketplace platform module or portal 200 can include a Customer Management System (CMS) delivery node module 202 which can be a portal for the marketplace platform and is in bidirectional communication with a Business Support Systems (BSS) product stack module or portal 210 (including any one or more of modules 212-220 illustrated in FIG. 2), and a CMS integration module or portal 206 for content management and integrating with various repositories. Users/customers module or portal 224 (e.g., a user terminal or client device) can access the marketplace via communication with CMS delivery node module or portal 202. In some embodiments, users/customers module or portal 224 can also be in communication with a Content Distribution Network (CDN) module or portal which is further in communication with modules or portals 202 and 206. In some embodiments, the CMS delivery node module or portal 202 can address a first customer interaction when the customer accesses the marketplace platform 200 according to one or more embodiments. For example, the CMS delivery node module or portal 202 can receive a request from a user terminal or portal 224 of the customer to view the available products/services, retrieve product/service data from a product catalog, and generate/present a graphical user interface (GUI) representation (e.g., column, list, etc.) illustrating available products/services of the marketplace platform or of one or more service providers or vendors. In addition, a product/content team module or portal 222 (e.g., a terminal or client devices of a seller, service provider, vendor, etc.) may also be in communication with the marketplace platform module or portal via communication with the CMS integration module or portal 206. In this case, the CMS integration module or portal 206 can generate and/or present GUI relevant to a seller, service provider, vendor, etc. (e.g., user interfaces for listing products for sale, configuring sales listings, generating or editing customer or product configuration profiles, promoting sales activity, etc.).

Still referring to FIG. 2, the marketplace platform module or portal 200 according to one or more embodiments may also include the BSS product stack module or portal 210. Here, module 210 may further include a product catalog module or portal 212 which can be a repository/data storage for storing product/service data. Further, module 212 may also include and store product/service level promotional offers or price reduction indicators or events associated with one or more stored products/services. Module 210 may also include a customer information management (CIM) module or portal 214 which can be a repository/data storage for storing customer information (e.g., name, contact information, ID, customer interest list, customer level promotional offers or price reduction events, etc.). Module 210 may also include a customer interaction management module or portal 216 which can be a repository/data storage for storing information of the customer's interaction with the marketplace platform according to one or more embodiments (e.g., the interaction history of the customer with the interactive elements of the graphical user interface (GUI), communications between the customer and the service provider(s) or other customer(s), etc.)

Still referring to FIG. 2, module 210 can also include a billing/invoice module or portal 218 for storing information associated with the customer's billing/invoicing on a service provided in the marketplace platform (e.g., previously created invoice, billing history, etc.). In addition, module 210 may also include a customer care/sales module or portal 220 for storing information of the sales or customer-related activities (e.g., sales campaign history, promotion activities for a specific type of customer, historical sales analysis, etc.). In some embodiments, module 220 can identify data associated with sales activity and user's experiences, retrieve/collect the data from external data storages or from any of modules or portals 212-218, store such data in a repository included in module 220, and provide such data to the network service provider/vendor when required. For instance, module 220 may provide sales related information or data to a sales team module 228, such that the sales team which is utilizing the sales team module 228 may utilize said information or data when required. Alternatively, module 220 can also be in communication with the product/content team module or portal 222. Here, the product/content team module or portal 222 can be users or a portal for users (e.g., vendors/service providers) who want to promote/sell network services. In addition, product/content team module or portal 222 can be a lead converter system or users who want to convert customer leads, analyze customer activity, and promote pre-sales and post-sales activities and marketing campaigns.

Still referring to FIG. 2, the marketplace platform module or portal 200 may also be in communication with an orchestrator module 230 (e.g., via an Application Programming Interface (API)). In particular, any one or more of modules or portals 212-220 of module 210 may be in communication with and/or supported by any of modules or portals 238-240 of module 230. Specifically, orchestrator module 230 can include a product/service management module 238 and a cloud orchestration module 240. In particular, any of modules 238-240 can be containerized and stored in a “cloud” or within cloud clusters on external servers and databases. In some embodiments, product/service management module 238 comprises a repository/data storage for storing products and services provided by a vendor/service provider. In some embodiments, the products and services are virtualized or are software-based. In some embodiments, the cloud orchestration module 240 is configured to schedule and provide the products and services to a user of the network services marketplace platform.

The modules illustrated in FIG. 2 are associated to the features for trading (e.g., selling, buying, promoting, etc.) a product or service in the marketplace platform. In addition to said modules in FIG. 2, the marketplace platform may also comprises modules for managing end-to-end processes (e.g., signup process, publish process, deploy process, operate process, etc.) of a product or service, as well as modules for managing one or more testing associated with said end-to-end processes.

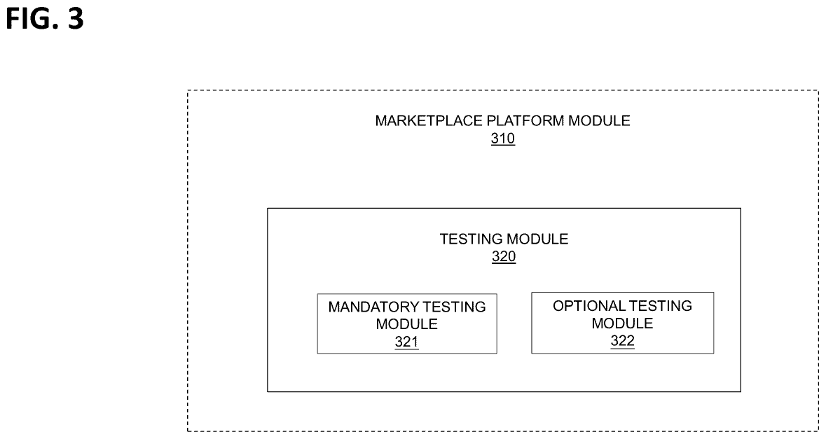

FIG. 3 illustrates an example block diagram of system modules for managing one or more testing, according to one or more embodiments. The marketplace platform module 310 in FIG. 3 may correspond to marketplace platform module 200 in FIG. 2, and may include one or more modules illustrated in FIG. 2, thus redundant descriptions associated therewith may be omitted below for conciseness.

Referring to FIG. 3, marketplace platform module 310 may comprise a testing module 320. The testing module 320 may be configured to perform and/or to manage one or more testing of one or more services in the marketplace platform throughout end-to-end processes of said one or more services (said one or more testing are referred to as “end-to-end testing” hereinafter).

The testing module 320 may be configured to provide a virtualized testing environment and to handle (e.g., perform, manage, etc.) one or more of the end-to-end testing in the virtualized test environment. The virtualized testing environment may provide a safe testing environment (e.g., a testing environment segregated from the existing system infrastructure and system operation) to perform one or more testing on a service before and/or after deploying said service in the marketplace platform.

The virtualized testing environment may comprise multiple types of testing environments, each of which may be provided for handling one or more testing during different stages. For instance, a lab or sandbox testing environment, which is separated from other running or deployed services in the marketplace platform, may be provided for handling testing at initial stages (e.g., designing of a service, initial trial run of a service, etc.), so as to mitigate system failures and/or any avoid service vulnerabilities from spreading during testing, while enable the estimation of the resources required for optimizing/developing the service and enable validation of the service configuration without affecting the operation of the marketplace platform. On the other hand, a staging testing environment, which may be a replica (with more or less resources) of the required system infrastructure and/or required system resources, may be provided for handling testing before actual deployment (e.g., acceptance testing to ensure the service fulfill acceptance criteria, etc.), so as to enable the simulation of the actual performance and functionality of the service. Similarly, an operation testing environment, which may be a replica of the current system infrastructure and/or available system resources, may be provided for handling testing after the service is deployed and is in operation.

Referring still to FIG. 3, the testing module 320 may comprise a mandatory testing module 321 and an optional testing module 322. The mandatory testing module 321 may be configured to handle (e.g., initiate, execute, configure, manage, monitor, etc.) one or more mandatory testing, and the optional testing module 322 may be configured to handle (e.g., initiate, execute, configure, manage, monitor, etc.) one or more optional testing.

The mandatory testing module 321 and/or the optional testing module 322 may be configured to perform one or more of the associated testing based on a predefined sequence. For instance, the mandatory testing module 321 may be configured to perform (e.g., automatically as soon as the service is uploaded to the marketplace platform, in response to an event, etc.) one or more mandatory testing on a service before one or more optional testing; while the optional testing module 322 may be configured to perform one or more optional testing after the operations associated with the mandatory testing module 321 have been completed. In some embodiments, the mandatory testing module 321 and/or the optional testing module 322 may be configured to perform one or more of the associated testing based on a priority level and/or urgency level defined by testing requestor and/or testing party. For instance, when a testing requestor uploads the service to the marketplace, the testing requestor may specify (e.g., via a GUI) the priority level (e.g., “important”, “intermediate”, etc.) of the service and/or the urgency level (e.g., “urgent”, “not urgent”, etc.) of the testing. Similarly, a testing party may intervene the testing process and appropriately adjust the urgency level of the testing. Subsequently, based on the specified priority level and/or urgency level, the mandatory testing module 321 and the optional testing module 322 may be configured to perform the associated testing accordingly (e.g., testing with high priority level/urgency level will be performed prior to testing with low priority level/urgency level, etc.).

By way of example, the one or more mandatory testing may comprise: one or more static testing, one or more acceptance testing, and/or one or more essential security testing.

The one or more static testing may be performed to verify a service without implementing or executing the service. For instance, one or more static testing may be performed to: (a) scan one or more programming codes associated with the service (without executing the programming codes) so as to check defect or deficiency in the programming codes, (b) verify a design of the service based on one or more designing documents, and (c) confirm that the service fulfills one or more essential system requirements. Since static testing may consume less resources and may be effective in detecting major defects and errors (which may in turns reduce overall testing cost and time as well as may effectively reduce the defects and errors at a later stage of testing), static testing may be performed during the initial stage of the testing (e.g., before running other tests, etc.).

In an example embodiment, the one or more static testing may include, but are not limited to, scanning on static objects (e.g., images, programming codes, requirement specifications, design documents, logs, matrix documents, Helm charts, Dockers, etc.). For instance, an image included in the service may be scanned to ensure that the image format complies with the system supported format, to ensure that the image does not include any sensitive words or contents, to avoid attachment of malicious item on the image, and the like. Further, a Helm chart may be scanned to ensure proper indentations, to ensure zero indentation errors, and the like. Furthermore, one or more source codes may be scanned to ensure that the source codes are readable by the system, to verify if any credentials are exposed in the source codes as plain text, and the like. Further still, one or more Dockers may be scanned to ensure that the version of the Dockers is up to date, to ensure that the contents of the Dockers comply with system requirements, and the like.

On the other hand, the one or more acceptance testing may be performed to verify the functionality and performance of the service, so as to ensure that the service meets one or more acceptance criteria before being deployed and utilized in the marketplace. The acceptance criteria are conditions that a service must satisfy to be accepted by a personnel (e.g., a customer, a system admin, etc.), and may be defined by the personnel based on, for example, needs of customers, feedback from other testing, a real-world situation or requirement, a service quality or performance indicated in a Service Level Agreement (SLA), a condition defined in standard operating environment (SOE), and the like. The one or more acceptance testing may comprise: performance testing, load testing, throughput testing, functional testing, stylistic testing, and the like.

Further, the one or more essential security testing may be performed to verify if a service complies with one or more minimal security requirements. For instance, the one or more essential security testing may comprise a quick scan on certain area or criteria of the service (e.g., criteria which considered by the system admin as critical, area of service which may affect the stability or operation of marketplace if being compromised, area of service which most likely contain threats or malicious files like malware, spyware, virus, etc.). The one or more essential security testing may provide essential security verification on the service in a short time, so as to reduce the risk of the service causing security issues after being deployed and utilized in the marketplace. Further, the one or more essential security testing may identify potential security issues (e.g., bugs, design deficiencies, etc.) of the service, such that the associated personnel can patch or update the service to address said potential security issues before the service is deployed and utilized in the marketplace.

It is apparent that the above mentioned static testing, acceptance testing, and essential security testing are merely examples of the one or more mandatory testing, and it is contemplated that the one or more mandatory testing may further comprise any other suitable testing which are considered as compulsory by the testing party, without departing from the scope of the present disclosure.

On the other hand, by way of example, the one or more optional testing may comprise: one or more integration testing, one or more dynamic testing, and one or more application testing.

The one or more integration testing may be performed to validate and reveal the service integration in the marketplace, such as: integration of a service with one or more system elements, integration of the service with other dependent service(s) in the marketplace (e.g., status monitoring, performance management, fault detection, inventory management, etc.), and the like. The one or more integration testing may validate that services can interoperate with each other (e.g., multiple services can operate or work together to deliver an intended function, etc.), determine the effectiveness or performance of different services when they are interoperating with each other, and determine potential defects or errors when the service are integrated to other existing elements in the marketplace.

In an example embodiment, the one or more integration testing may comprise: one or more configuration testing, one or more container testing, one or more reachability testing, and one or more service compatibility testing. The one or more configuration testing may be performed to analyze configuration associated with a service to identify potential error(s) or inconsistency(s) in said configuration. For instance, the one or more configuration testing may comprise a Linting process, in which the codes and files associated with the configuration of the service are processed and analyzed to determine any potential programmatic and/or stylistic error. On the other hand, the one or more container testing be performed to ensure container(s) associated with a service can operate (e.g., startup, function, etc.) normally when being utilized. For instance, the one or more container testing may comprise a container startup testing, in which a trial run of container(s) associated with the service is performed and the status of the container(s) such as status of the pod(s) associated with the container(s) is validated after the trial run so as to determine whether or not the container(s) can operate as expected upon integrating into the marketplace platform. Further, the one or more reachability testing may be performed to verify the connection among the service and other elements in the marketplace, so as to verify if the service is reachable by said other elements after being implemented. For instance, the one or more reachability testing may comprise a ping test between two elements (e.g., services, containers, pods, etc.), a telnet connectivity testing to determine available ports (e.g., transmission control protocol (TCP) ports, etc.), a secure shell (SSH) connectivity testing, a connection time out testing, an API testing, and the like. Furthermore, the one or more service compatibility testing may be performed to verify if a service is compatible with other services in the marketplace platform and check the interoperability among the services. For instance, the one or more service compatibility testing may comprise infrastructure or resource compatibility testing (e.g., testing to verify whether or not the infrastructure or resource required by the service is compatible with the configuration of other services, etc.), operating system compatibility testing (e.g., testing to verify whether or not the service is compatible with operating system of other services, etc.), software compatibility testing (e.g., to test if the software coding is compatible with other services, etc.), and the like.

The one or more dynamic testing may be performed to verify a service via executing the service. Specifically, one or more dynamic testing may be performed to test the behavior of the service with dynamic variables in runtime, and to verify the service by comparing the actual runtime behavior to the expected behavior. For instance, the one or more dynamic testing may comprise one or more functional testing (e.g., unit testing, system testing, etc.) and/or one or more non-functional testing (e.g., recovery testing, usability testing, etc.). In some embodiments, the one or more dynamic testing may comprise security testing such as dynamic application security testing (DAST).

The one or more application testing may be performed to verify the overall software application behavior of a service. In some embodiments, the one or more application testing may comprise one or more front-end functionality testing, one or more back-end functionality testing, and/or one or more end-to-end functionality testing. For instance, the one or more application testing may comprise: GUI testing, database testing, load testing, and the like. The one or more application testing may be different according to the type of the application. For instance, a testing for a Python-based application may have different workflows or pipelines as compared to a JSON-based application, a Jenkins-based application, and the like.

It is apparent that the above mentioned integration testing, dynamic testing, and application testing are merely examples of the one or more optional testing, and it is contemplated that the one or more optional testing may comprise any other suitable tests which are considered as optional by the testing party, without departing from the scope of the present disclosure. Furthermore, one or more of the optional testing may allow the testing requestor to use one or more specific testing scripts, and may be triggered as a part of pre or post deployment of the service. To this end, the testing requestor may upload different types of scripts to test their services (e.g., Java, YAML, Shell, JSON, Python, etc.). These scripts may be stored in a specific storage location from which testing requestor could initiate the application testing.

Referring back to FIG. 3, the testing module 320 (or the module 321 and/or module 322 included therein) may be configured to automatically perform one or more of the abovementioned testing based on a respective testing processes, workflows, and/or pipelines.

For instance, each of the testing may have a testing profile associated therewith, wherein the testing profile may comprise the information and configuration of the respective testing process, rules and policies, workflows, settings, and the like. Some of the testing profiles may be predefined by the user (testing party and/or testing requestor) before the testing and/or may be configurable by the user during or after the testing. Alternatively, some of the testing profiles may be generated or adjusted by the testing module 320 based on, for example, user requirements, testing history, system conditions, and the like. For instance, the user may specify the requirement via a GUI(s), and the testing module 320 may search for appropriate testing algorithms, workflows, and the like, from internal database (e.g., obtain from any testing profile(s) which has similar user's requirement, etc.) and/or from external database (e.g., search for testing profile(s) based on keywords, etc.), and then generate a testing profile accordingly. Further, each of the testing profiles may have a unique profile ID assigned thereto.

In some embodiments, the testing module 320 may be configured to collect and compile the testing related information and/or materials, and may be configured to provide the same to the user (testing party and/or testing requestor) who would like to monitor or manage the testing, so that the user may review, inspect, and or adjust the testing (e.g., by adjusting the testing profile, etc.) when required.

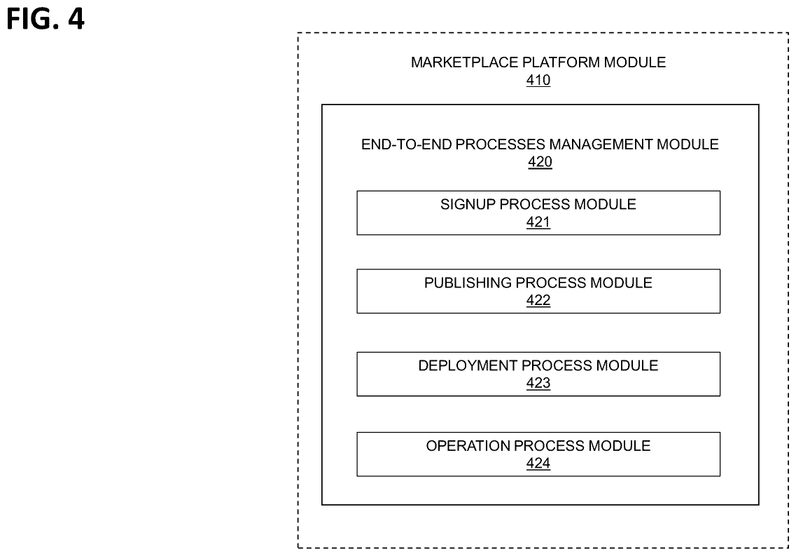

FIG. 4 illustrates an example block diagram of system modules for managing one or more end-to-end processes, according to one or more embodiments. The marketplace platform module 410 may correspond to marketplace platform module 200 in FIG. 2 and/or may correspond to marketplace platform module 310 in FIG. 3, and may include one or more modules illustrated in FIG. 2 and/or FIG. 3, thus redundant descriptions associated therewith may be omitted below for conciseness.

Referring to FIG. 4, the marketplace platform module 410 may comprise end-to-end processes management module 420, which may be configured to handle end-to-end processes of a service, such as: signup process, publish process, deployment process, and operation process. Further, the end-to-end process management module 420 may be communicatively coupled to one or more of the above described modules in the marketplace platform module (e.g., modules illustrated in FIG. 2 and/or FIG. 3) in handling the end-to-end processes. For instance, the end-to-end process management module 420 may be communicatively coupled to the testing module 320 in FIG. 3, so as to provide testing or the related features in one or more end-to-end processes (further discussed below).

In an example embodiment, the end-to-end processes management module 420 and the various operations thereof are provided by executing instructions embodied by a microservice architecture, i.e., an application architecture composed of a plurality of independently executable services. It is understood that one or more other embodiments are not limited thereto, and the end-to-end processes management module 420 may utilize a different application or software design architecture (e.g., monolithic).

In an example embodiment, the end-to-end processes management module 420 may comprise a signup process module 421, a publishing process module 422, a deployment process module 423, and an operation process module 424, each of which may be configured to perform a respective end-to-end process, i.e., signup process, publishing process, deployment process, and operation process. Each of the signup process, the publishing process, the deployment process and the operation process may be defined in the form of one or more or more microservices.

Different types of users (i.e., users with different roles) may be involved in one or more of the end-to-end processes. For example, all users may be involved in the signup process; users with a developer (e.g., vendor, service provider, etc.) role and a reviewer role may be involved in the publishing process; users with at least one of a operator (e.g., customer) role, an administrator role and a reviewer role may be involved in the deployment process and the operation process.

In this regards, the signup process module 421 may be configured to guide a user through a signup process so as to allow the user to be on-boarded and/or authenticated in a standardized manner (i.e., in predetermined user schemas having predetermined roles and privileges). Further, the publishing process module 422 may be configured to provide a secure and rapid publishing process of a service in the marketplace. Furthermore, the deployment process module 423 may be configured to provide a secure and rapid deployment process of the service in the marketplace. In addition, the operation process module 424 may be configured to provide a monitoring and lifecycle-control process of products and services throughout the operation of the products and the services in the marketplace.

Further, each of the signup process module 421, the publishing process module 422, the deployment process module 423, and the operation process module 424 may be configured to provide different sets of operations and/or GUI(s) for the associated personnel during the corresponding process. For instance, the publishing process module 422 may provide a first set of operations and/or GUI(s) to a user with a developer role and a second set of operations and/or GUI(s) to a user with a reviewer role, with one or more differences between the two sets. Similar processes may be applicable to other end-to-end processes modules (i.e., modules 422, module 423, and/or module 424.).

In an example embodiment, the publishing process module 422 may be configured to provide a set of operations and/or GUI(s) to allow users to upload their products or services (e.g., programming packages of the products or services), product information, parameters, artifacts, and the like, to the marketplace. Similarly, the deployment process module 423 may be configured to provide a set of operations and/or GUI(s) to allows users to deploy a published product or service in the marketplace. For instance, via the GUI(s), a user (e.g., user with developer role, etc.) may make a request for deploying a service, and another user(e.g., user reviewer role, etc.) may approve the request. Likewise, the operation process module 424 may be configured to provide a set of operations and/or GUIs to allow users to connect to and select one or more services, to manage the lifecycle and operation of the selected service(s), and the like.

In addition, one or more of the above mentioned modules of end-to-end processes management module 420 may be configured to communicatively couple to a testing module (e.g., module 320 in FIG. 3), and may be configured to provide one or more testing or the related features in the respective end-to-end processes. For instance, the publishing process (handled by publishing process module 422) may include one or more mandatory testing (e.g., static testing, essential security testing, etc.) and/or one or more optional testing (e.g., integration testing, etc.) on a service before the publishing or publication of the service in the marketplace. Similarly, the deployment process (handled by deployment process module 423) may include one or more mandatory testing (e.g., static testing, acceptance testing, etc.) and/or one or more optional testing (e.g., integration testing, application testing, etc.) on a service before deploying the service on the marketplace and before allowing other users to utilize the service. Likewise, the operation process (handled by the operation process module 424) may include one or more mandatory testing (e.g., static testing, essential security testing, etc.) and/or one or more optional testing (e.g., dynamic testing, application testing, etc.) before, during or after the operation of the service.

By way of example, the GUI(s) provided by the modules of end-to-end processes management module 420 may allow users to configure, customize, and/or manage one or more testing throughout the end-to-end processes of a service. For instance, the publishing process module 422 may receive inputs from a testing requestor via the GUI(s), and provide the input of the testing requestor to other modules such that a customized testing may be computed based on said input and the testing module may then perform the customized testing accordingly. Further, the publishing process module 422 may be configured to receive information or data from the other modules to update the GUI(s) to include the latest testing information (e.g., testing configuration, testing status, testing logs, etc.). Once the testing have completed successfully, the product or service may be published by the publishing process module 422 in the marketplace. It is apparent that one or more testing involved in other end-to-end processes may be provided and managed in a similar manner.

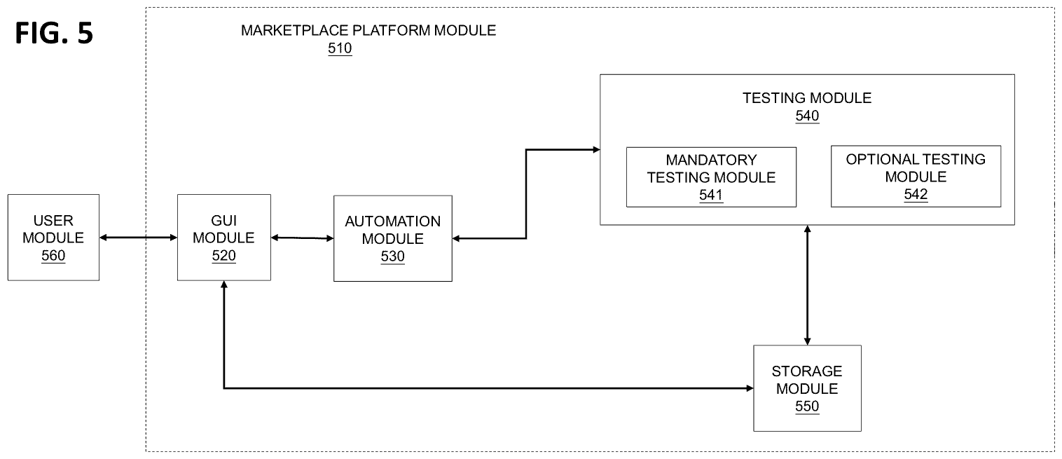

FIG. 5 illustrates an example block diagram of a system for managing end-to-end testing, according to one or more embodiments.

Referring to FIG. 5, the marketplace platform module 510 may comprise a GUI module 520, an automation module 530, a testing module 540, and a storage module 550. Further, the marketplace platform module 510 may be communicatively coupled to a user module 560.

To this end, the marketplace platform module 510 may correspond to marketplace platform module 200 in FIG. 2, marketplace platform module 310 in FIG. 3, and/or marketplace platform module 410 in FIG. 4. Further, the testing module 540 may correspond to testing module 320 in FIG. 3, the GUI module 520 may correspond to any module which is capable of generating and presenting one or more GUIs (e.g., CMS delivery node module 202 or CMS integration module 206 in FIG. 2, end-to-end processes management module 420 in FIG. 4, etc.), and the user module 560 may correspond to any module which is capable of communicating with a user (e.g., module 222, module 224, or module 228 in FIG. 2, etc.). Thus, the associated operations and features described above are similarly applicable herein unless specifically described otherwise, and the redundant descriptions associated therewith may be omitted below for conciseness.

Referring to FIG. 5, the GUI module 520 may be communicatively coupled to the user module 560, the automation module 530, and the storage module 550. In an example embodiment, the GUI module 520 may be configured to generate and present one or more GUIs to a user (e.g., testing requestor such as a vendor, a service provider, or a developer, and/or testing party such as a system admin, etc.) via the user module 560. The one or more GUIs may comprise information of a service associated with the user. For instance, the one or more GUIs may comprise application information of the service, document and specification associated with the service, configuration and setting of the service, network or computing resource assigned to or required by the service, process status (e.g., uploaded, published, deployed, etc.), testing related information (e.g., testing status, testing log, testing result, potential issue identified from the testing, system recommendation based on the testing result, etc.), and any other suitable information which may provide the user a comprehensive view on the service.

Further, the one or more GUIs may comprise one or more interactive elements (e.g., check box, button, slider, etc.), with which the user may interact to configure and customize one or more testing. Specifically, one or more of the interactive elements in the one or more GUIs may be mapped to a respective testing information (e.g., testing profile), such that upon being interacted by the user, the GUI module 520 may be configured to collect or compile the information of the user's intended testing and provide the same to the automation module 530 for further processing.

By way of example, assuming that a user want to perform two optional testing, such as integration testing 1 and dynamic testing 2, on a service. In this regard, the user may simply select (e.g., click on the respective check box, etc.) said integration test 1 and dynamic test 2 on the GUI, and click on a “Run Testing” button. Accordingly, GUI module 520 may collect the testing profile ID of integration testing 1 and the testing profile ID of dynamic testing 2, and provide said testing profile IDs to the automation module 530.

The automation module 530 may be communicatively coupled to the GUI module 520 and the testing module 540. In an example embodiment, the automation module 530 may be configured to received information (e.g., testing profile IDs associated to user's selected testing, etc.) from the GUI module 520, and may be configured to automatically generate a testing scheme based on the information received from the GUI module 520. In this way, the testing scheme may define a customized testing process or workflow, such as: one or more testing selected by the user, a sequence for performing said one or more testing, a starting time and/or ending time for performing said one or more testing, priority level and/or urgency level of the testing, specific criteria to be tested during the one or more testing, schedule for regularly or periodically repeat the one or more testing, and the like.

Subsequently, the automation module 530 may be configured to provide the generated testing scheme to the testing module 540 such that testing module 540 may execute the associated testing accordingly. In an example embodiment, the automation module 530 may be configured to generate, based on the received information (e.g., testing profile ID, etc.), an API call (e.g., a real-time API, a FastAPI, etc.) to provide the testing scheme or the associated information to the testing module 540. In another embodiment, the automation module 530 may be configured to include (in the testing scheme) a query, such as structured query language (SQL) query, language integrated query (LinQ), hibernate query language (HQL) query, Scala query language (ScalaQL) query, and the like. In some embodiments, the automation module 530 may comprise one or more automation servers (e.g., Jenkins, GitLab, etc.).

The testing module 540 may be communicatively coupled to the automation module 530 and the storage module 550, and may comprise a mandatory testing module 541 and an optional testing module 542 (which may correspond to mandatory testing module 321 and optional testing module 322 in FIG. 3, respectively). The testing module 540 may be configured to receive the testing scheme or the associated information (e.g., in the form of API call, interactive query, etc.) from the automation module 530 and may be configured to perform one or more testing according to the testing scheme.

For instance, the testing module 540 may be configured to obtain testing profile(s) associated with one or more testing defined in the testing scheme (e.g., received from automation module 530) and execute the one or more testing based on the associated testing profile. Further, the testing module 540 may be configured to verify the testing scheme before executing one or more testing defined therein, so as to ensure that the algorithms or requirement defined in the testing scheme are accurate and/or are feasible.

By way of example, the automation module 530 may determine that the testing scheme indicates a mandatory testing should be performed after an optional testing, while the configuration profile of said mandatory testing indicates that said mandatory testing should be performed before any optional testing. In that case, the testing module 540 may provide a response to the automation module 530 such that the automation module 530 may adjust or update the testing scheme accordingly, or may provide a recommendation on the revised testing scheme and provide the same to automation module 530. Accordingly, the automation module 530 may provide the revised testing scheme to the GUI module 520, and the GUI module 520 may update the GUI to inform the user about the recommended testing scheme.

In some embodiments, the GUI(s) provided to the user may include a search box in which the user may simply defines the required testing (e.g., by inserting a keyword, by selecting a tag, etc.). Subsequently, the GUI module 520 may receive the testing requirement and send the testing requirement to the automation module 530, and the automation module 530 may process the testing requirement to generate queries, API calls, etc. for requesting associated testing based on the keyword, tags, and the like. In this regard, the automation module 530 may also be configured to search for one or more associated testing and provide testing recommendation to the user. By way of example, assuming that the user would like to perform an integration test between his service and a cloud storage A but the cloud storage A is not available in the marketplace, the user may simply specify his intended feature (e.g., “cloud native”, “hosting on cloud”, “backup storage”, etc.) via the GUI(s) provided by GUI module 520, and the automation module 530 and testing module 540 may automatically determine service(s) which has similar feature and the associated testing, and recommend the same to the user via the GUI(s).

Upon executing the testing, the testing module 540 may be configured to continuously or periodically store the testing information, such as testing status (e.g., pending, in progress, successful, failed, etc.) and the testing result (e.g., testing log, tested criteria, service performance during testing, reason of testing failure (if any), warning on any potential defect or error detected during testing, etc.), in the storage module 550.

The storage module 550 may be communicatively coupled to the testing module 540, and may be configured to receive testing information or data (e.g., testing status, testing result, etc.) therefrom and to store the received information or data in one or more associated storage mediums. In an example embodiment, the storage module 550 may comprise at least two storage mediums (e.g., database, server, etc.), wherein the testing status may be stored in one of the at least two storage mediums and the testing result/log may be stored in the another one of the at least two storage mediums. In this regards, the storage medium storing the testing statuses may be communicatively coupled to or accessible by other services (e.g., observability or monitoring service, etc.) in the marketplace platform, such that the testing status stored therein may be utilized by said other services. In some embodiments, the storage medium storing the testing result or log may be an object storage (e.g., MinIO, etc.). Furthermore, although it is illustrated in FIG. 5 that the storage module 550 is included in the marketplace platform module 510, it is contemplated that the storage module may also be any suitable storage medium external to the marketplace platform module 510, without departing from the scope of the present disclosure.

Also, the storage module 550 may be communicatively coupled to the GUI module 520, and may be configured to provide the stored information or data to the GUI module 520. For instance, the storage module 550 may be configured to continuously or periodically provide information or data of testing status and/or testing report/log to the GUI module 520. Alternatively, GUI module 520 may be configured to continuously or periodically scan the storage module 550 for new information or data associated to one or more GUIs presented to the user, and may then be configured to send to the storage module 550 a request for obtaining the new information or data, if any. In an example embodiment, the storage module 550 may be configured to provide the information or data in a data batch or in a data bundle.

Upon receiving the information or data from the storage module 550, the GUI module 520 may be configured to generate a new GUI(s) or to update a presented GUI(s) to include the associated information. For instance, the GUI module 520 may be configured to update GUI(s) of a testing workspace to present the latest or updated status of each testing selected by the user.

On the other hand, upon determining that one or more testing reports or logs are available in the storage module 550, the GUI module 520 may be configured to update the GUI(s) of the testing workspace to include one or more interactive elements (e.g., button, clickable icon, etc.) to the testing workspace. Accordingly, the user may interact (e.g., double clicking, pressing a key, etc.) with the interactive elements to view (e.g., view locally via downloading, view online via the testing workspace, etc.) the status reports or logs.

To this end, the above mentioned embodiments provide a system and method which allows one or more testing to be handled effectively. For instance, the GUI module 520 may provide one or more GUIs which form a testing workspace that provide comprehensive testing information, such as testing options, testing statuses, testing types, testing results, and the like, while allowing the user to easily and effectively manage or customize one or more testing for a service. Based on the user's interaction with the one or more GUIs, the automation module 530 may automatically or dynamically generate a customized testing scheme for the user, and the testing module 540 may automatically execute one or more testing according to the testing scheme. The detail status of the testing may be automatically and effectively presented to the user via the testing workspace, which allows the user to have a comprehensive view and increases the user's experience. Further, the testing reports or logs may be easily viewed or obtained by the user.

Several example embodiments of testing workspace are described in the following, with reference to the associated GUIs.

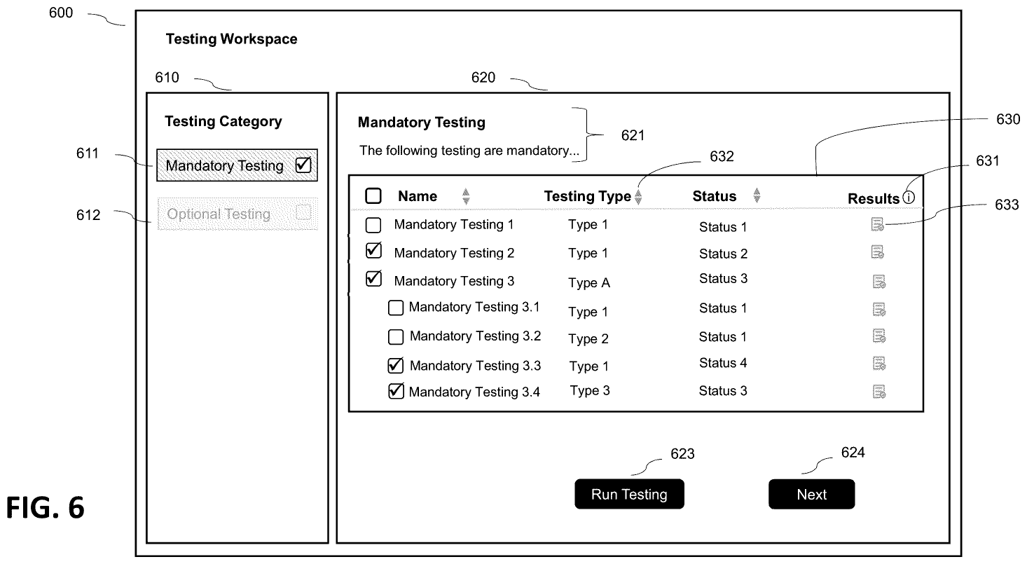

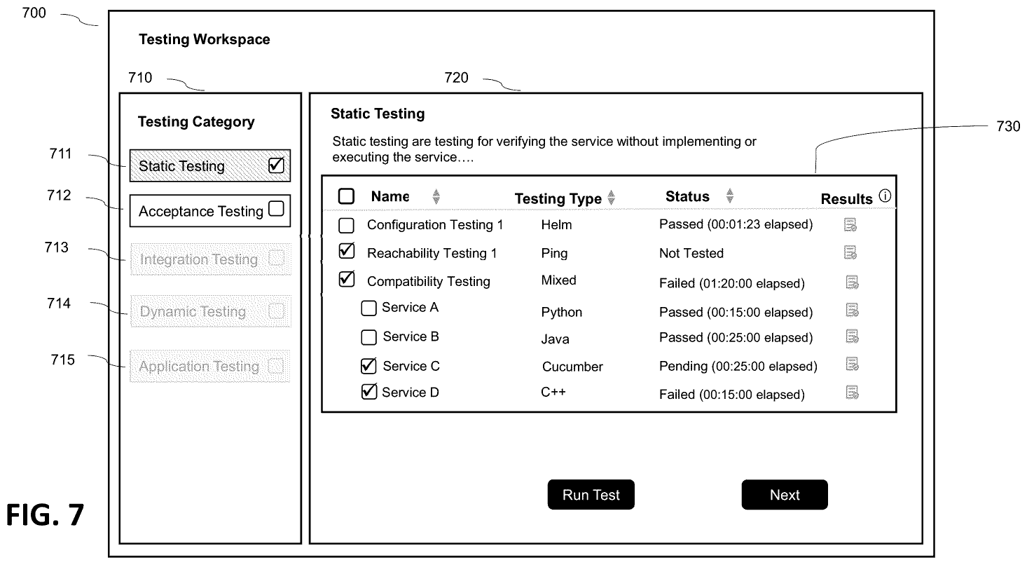

FIG. 6 illustrates a generalized GUI of a testing workspace, according to one or more embodiments. On the other hand, FIG. 7 illustrates an example GUI of the testing workspace, according to one or more embodiments. For descriptive purpose, some descriptions of FIG. 6 may be provided with reference to FIG. 7. Further, some elements in FIG. 7 may overlap with elements in FIG. 6, thus the descriptions of said overlapping elements may be omitted below for conciseness.

Further, the GUI 600 may be generated by and presented by the GUI module 520 in FIG. 5. For instance, whenever a user accesses the marketplace (e.g., via user module 560, etc.), the GUI module 520 may collects (e.g., from the user module 560, etc.) testing information associated with the user (e.g., based on a user profile, user ID, etc.) and generates GUI 600 accordingly.

Referring to FIG. 6, GUI 600 may comprise a first partition 610 and a second partition 620. The first partition 610 may comprise one or more blocks illustrating one or more available testing categories, which may be determined by the GUI module 520 based on the user's information. In the example embodiment in FIG. 6, the first partition 610 comprises a first block 611 showing an available mandatory testing category, and a second block 612 showing an available optional testing category. Nevertheless, it is contemplated that different users may have different available testing category(s) presented in the first partition 610. By way of example, testing workspace of user 1 may have two mandatory testing categories (e.g., static testing, acceptance testing, etc.) and one optional testing category (e.g., integration testing, etc.) presented in the associated first partition, while testing workspace of user 2 may have one mandatory testing category (e.g., essential security testing, etc.) and two optional testing categories (e.g., dynamic testing, application testing, etc.) presented in the associated first partition.

Referring back to FIG. 6, each of the first block 611 and second block 612 may comprise a check box which is interactable or selectable by the user. In the example embodiment in FIG. 6, the selection on the second block 612 is disabled (e.g., by the GUI module 520), since the associated testing party may require the user to complete the configuration of mandatory testing before configuring the optional testing (i.e., the selection of the second block 612 may only be available after the mandatory testing has been configured). However, it is contemplated that the selection on the second block 612 may be enabled along with or before the selection on the first block 611, without departing from the scope of the present disclosure.

Further, it is also apparent that the first partition 610 may comprise less or more blocks than illustrated in FIG. 6. For instance, referring to FIG. 7, the first portion 710 may comprise: a first block 711 of static testing, a second block 712 of acceptance testing, a third block 713 of integration testing, a fourth block 714 of dynamic testing, and a fifth block 715 of application testing. In this case, blocks 711 to 712 fall under one testing category (i.e., mandatory testing category), while blocks 713 to 715 fall under another testing category (i.e., optional testing category). The user may opt to configure any of the mandatory testing, i.e., static testing and acceptance testing, by clicking on the respective check box. The selected block will be presented in a distinguishing manner (e.g., highlighted, filled with a pattern, etc.) from other block(s) which falls under the same testing category. In the example embodiment in FIG. 7, the static testing is selected, thus the associated block (i.e., first block 711) is configured to be filled with diagonal lines and the associated check box is updated to include a check mark.

Referring back to FIG. 6, the second partition 620 may comprise a testing descriptions 621, a sub-window 630, and a plurality of interactive elements 623-624. The content of the second partition may be associated with the testing category selected by the user in partition 610. Specifically, based on the user's selection in the first partition 610, the GUI module 520 may generate or update the content in the second partition 620 accordingly. By way of example, based on determining that the user has selected static testing in the first partition, the GUI module 520 may generate or update the second partition to include information of static testing associated with the user (as illustrated in FIG. 7).

The testing descriptions 621 may comprise a title of the testing and a summary or brief description of the testing (for instance, the corresponding portion in FIG. 7 illustrates an example testing descriptions associated with static testing). The content of testing description 621 may be pre-defined by the testing party or by any other suitable personnel. In some embodiments, the testing descriptions 621 may include a summary of testing history. For instance, the testing descriptions 621 may include information of testing which has been performed in the past, testing which has not been completed, errors or defects determined from previous testing, and the like. In this way, an inexperienced user may get a comprehensive understanding on the selected testing, which may be helpful for said user in deciding how to configure or customize the testing for the service.

Referring still to FIG. 6, the sub-window 630 may comprise multiple columns each of which defines an information group (e.g., name of testing, testing type, status of testing, results of testing, etc.), and may comprise multiple rows each of which include information of one or more available testing (testing associated to the testing category selected by the user in partition 610). For instance, referring to FIG. 7, since static testing has been selected in the first partition 710, the information of available static testing (e.g., configuration testing 1, reachability testing 1, compatibility testing, etc.) are being presented in the sub-window 730 of the second partition 720.

Referring back to FIG. 6, the sub-window 630 may comprise one or more interactive element 631, one or more interactive elements 632, and one or more interactive elements 633.

The one or more interactive elements 631 may be icons which, when being interacted with by the user (e.g., hovering over, scrolling through, clicking, etc.), present information associated therewith. For instance, when the user interacts with interactive element 631 associated with the “Results” column (e.g., the user taps the interactive element 631 via a screen of user module 560, etc.), the summary of the testing results will be presented in, for example, a hover-over window, a pop-out window, and the like. It is contemplated that interactive element 631 may also be associated with any other information in the testing workspace. For instance, one or more interactive elements 631 may be associated with each of the testing listed in sub-window 630, such that when the user interacts with said one or more interactive elements 631, the information associated therewith will be presented. By way of example, referring to FIG. 7, one or more of the configuration testing 1, reachability testing 1, and compatibility testing may have an interactive element 631 associated therewith, such that when the user interacts with the respective interactive element 631, the summary or description of the testing will be presented.

Referring back to FIG. 6, the one or more interactive elements 632 may be one or more icons which, when interacted by the user (e.g., clicking, etc.), rearrange the sequential presentation of the information in sub-window 630. For instance, when the user clicks the up icon of element 632 associated with the testing type, the GUI module 520 may be configured to generate a new GUI or update the GUI 600, with the testing information included in the sub-window 630 re-arranged according to the testing type (e.g., testing with testing type 1 will be presented first, following by testing with testing type 2, etc.), according to the alphabetical order of the testing, and the like. Similar interactive element may be associated with other testing information, such as testing name, testing status, testing results, and the like, and the information in sub-window 630 may be rearranged according to the testing name, testing status, testing results, and the like, in a similar manner.

The one or more interactive elements 633 may be one or more icons which, when being interacted by the user (e.g., clicking, etc.), obtain the associated testing results or logs for the user. For instance, when the user clicks the element 632 associated with mandatory testing 1, the GUI module 520 may be configured to obtain (e.g., from storage module 550, etc.) testing results or logs associated with mandatory testing 1, and then present the obtained testing results or logs (e.g., in a pop-out window, etc.) to the user. Further, upon detecting a user interaction on element 632, the associated testing results or logs may be downloaded by the user module 560. In some embodiments, upon detecting a user interaction on element 632, testing results or logs of all testing presented in the sub-window 630 (or one or more testing selected in sub-window 630) may be downloaded in a compiled document.

Referring still to FIG. 6, the check box associated with the testing may be pre-populated by the GUI module 520. For instance, during generation of GUI 600, the GUI module 520 may determine which associated mandatory testing were completed successfully and which have not, and may then pre-populate the check box for mandatory testing which have not yet complete. By way of example, GUI module 520 may determine that mandatory testing 1, mandatory testing 3.1, and mandatory testing 3.2 have been completed successfully, while other mandatory testing have not yet completed. Thus, when generating sub-window 630, the GUI module 520 may be configured to pre-populate check boxes of testing other than mandatory testing 1, mandatory testing 3.1, and mandatory testing 3.2.

Further, the interactive elements 623 and 624 of second partition 620, when being interacted by the user (e.g., hovering over, scrolling through, clicking, etc.), performs an action associated therewith. For instance, after selecting or configuring one or more testing to be executed, the user may interact with element 623 to initiate the testing processes. Upon detecting the user's interaction on element 623, the GUI module 520 may be configured to compile the information of the selected testing (e.g., generate a list of selected testing, collect the testing profile ID of each selected testing, etc.) and provide said information to the other modules. For instance, the information may be provided to the automation module 530, and the automation module 530 may be configured to generate a testing scheme based on the user's selected testing, and then provide the generated testing scheme to the testing module 540 such that testing module 540 may then be configured to execute the user's selected testing based on the testing scheme.

Alternatively, the user may interact with element 624 so as to continue to configure one or more testing of the next category (e.g., optional testing, 612, etc.). For instance, upon detecting that the user has interacted with element 624, the GUI module may update the testing workspace of GUI 600, such that the content of the first partition 610 and the second partition 620 are updated accordingly.

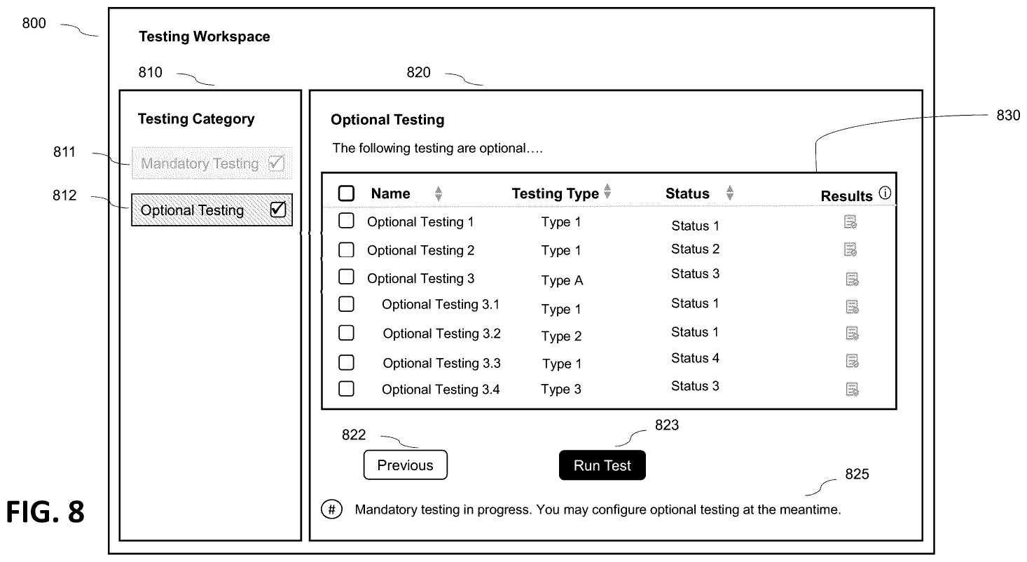

FIG. 8 illustrates an example of another generalized GUI of the testing workspace, according to one or more embodiments. The GUI 800 in FIG. 8 may illustrates a testing workspace upon detecting a user's interaction with interactive element 624 (i.e., “Next” button) in FIG. 6, which indicates that the user would like to continue with configuration of optional testing subsequent to the configuration of mandatory testing. Further, some elements in FIG. 8 may overlap with elements in FIG. 6, thus redundant descriptions of said overlapping elements may be omitted below for conciseness.

Referring to FIG. 8, the first block 811 and the second block 812 in first partition 810 may be presented in a manner different from the first block 611 and the second block 612 in the first partition 610 in FIG. 6, so as to notify the user that the configuration of the testing category of the first block (e.g., mandatory testing) were completed and the contents showing on the testing workspace are now associated with testing category of the second block (e.g., optional testing).

The second partition 820 may comprise contents, information, and interactive elements, associated with optional testing defined in the second block 612, in a similar manner as described in relation to the second partition 620 in FIG. 6. In addition, the second partition 620 may comprise an additional interactive element 822 which, when being interacted by the user, redirect the user to the previous testing workspace (e.g., the GUI 600 in FIG. 6, etc.), so that the user may adjust or reconfigure the configured testing in the previous testing workspace. Further, the second partition 820 may also comprise a status summary 825, which may present status of testing configured in the previous testing workspace.

In the example embodiment illustrated in FIG. 8, the mandatory testing is not yet completed. Thus, the user may either continue to configure other available testing (e.g., optional testing), or may opt to simply wait for the completion of the mandatory testing, before the user can deploy the service.

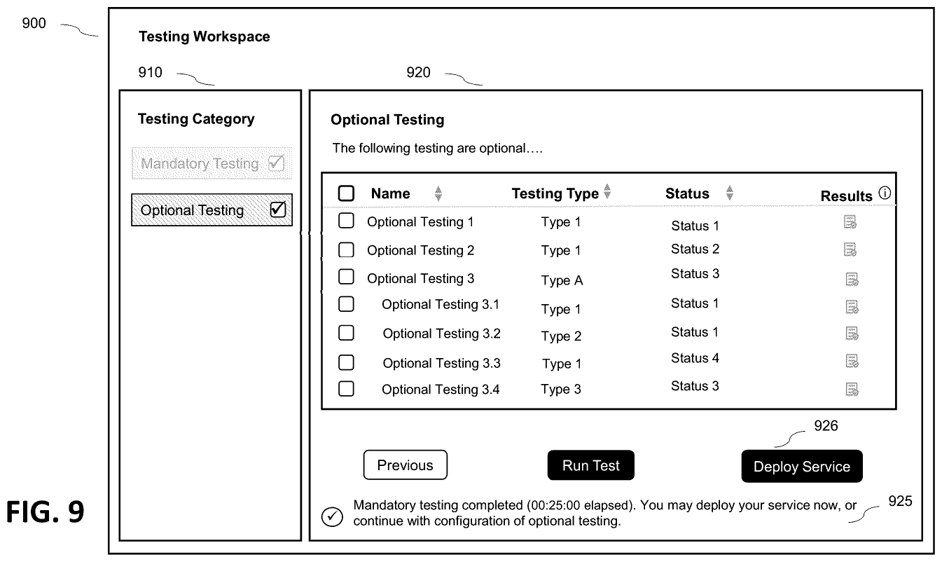

FIG. 9 illustrates an example of another generalized GUI of the testing workspace, according to one or more embodiments. The GUI 900 in FIG. 9 may illustrates a testing workspace similar to the one in GUI 800, after the mandatory testing is completed. Thus, some elements in FIG. 9 may overlap with elements in FIG. 9, and the redundant descriptions of said overlapping elements may be omitted below for conciseness.

Referring to FIG. 9, the second partition 920 may include a status summary 925. The status summary 925 may be an updated version of status summary 825 in FIG. 8, which may present updated status of testing configured in the previous testing workspace. In addition, the second partition 920 may comprise an additional interactive element 926 upon detecting that the service is ready to be deployed (e.g., mandatory testing were completed, etc.). Accordingly, when the interactive element 926 is being interacted by the user, the GUI module 520 may trigger the deploy process (via deploy process module 423 in FIG. 4, etc.) for the service.

It is contemplated that FIG. 6 to FIG. 9 and the associated descriptions are provided herein merely for descriptive purpose, and the GUI of the testing workspace should not be limited thereto. Specifically, the GUI of the testing workspace may be presented in a different manner (e.g., the first partition may be presented in the above portion of the GUI and the second partition may be presented in the below portion of the GUI, etc.), the GUI may include less or more information, the GUI may include less or more interactive elements, and the like, without departing from the scope of the present disclosure. Further, the testing workspace may also be applicable to other end-to-end processes, such as publishing process, operation process, and the like, without departing from the scope of the present disclosure.

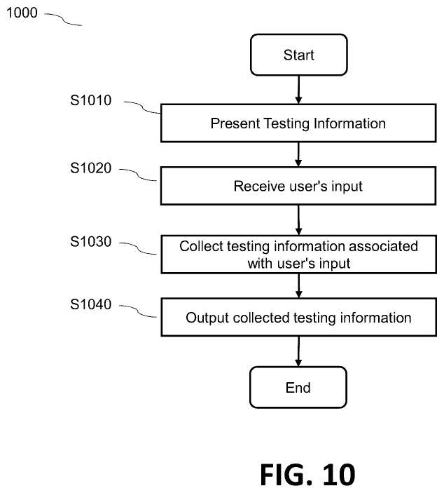

FIG. 10 illustrates an example flow diagram of a method 1000 for interacting with a user to configure one or more testing, according to one or more embodiments. Method 1000 may be performed by GUI module 520 in FIG. 5.

Referring to FIG. 10, at operation S1010, testing information are presented to a user. Specifically, a GUI module (e.g., module 520) may be configured to generate a GUI containing information of one or more testing associated with a service of the user, and may then present the GUI to the user via a user module (e.g., module 560).

For instance, the GUI module may be configured to receive user's information (e.g., user ID, user's profile, etc.) from the user module, to determine a service associated with the user based on the user's information, to collect testing information associated with determined service (e.g., testing previously performed on the service, testing available for the service, testing status of the service, etc.), and to generate the GUI based on the collected testing information.

In some embodiments, the generated GUI may comprise a first partition (e.g., first partition 610, etc.) and a second partition (e.g., second partition 620, etc.), wherein the first partition may comprise one or more blocks (e.g., block 611, block 612, etc.) each of which may comprise information of available testing category (e.g., mandatory testing, optional testing, etc.), and wherein the second partition may comprise: (a) a description (e.g., testing description 621) of the testing category selected in the first partition; (b) a sub-window (e.g., sub-window 630) comprises one or more available testing associated with the testing category selected in the first partition and one or more interactive elements (e.g., element 631, element 632, element 633, etc.); and (c) one or more interactive elements (e.g., element 623, element 624, etc.). Each of the one or more interactive elements in the sub-window of the second partition may be associated with the one or more available testing (e.g., mapped with a testing profile ID associated with the respective testing, etc.). For instance, a check box of mandatory testing 1 may be mapped to a testing profile ID of testing profile 1.

Referring still to FIG. 10, at operation S1020, a user's input is received. Specifically, the GUI module may be configured to receive a user selection of one or more testing. In some embodiments, the GUI module may be configured to receive a user interaction with one or more interactive elements (e.g., check box, etc.) associated with available testing.

At operation S1030, testing information associated with the user's input is collected. Specifically, the GUI module may be configured to collect information of the user's selected testing. For instance, the GUI module may be configured to determine which testing has been selected by the user based on the user's input. By way of example, based on determining that the user has interacted (e.g., checked, clicked, etc.) with the check boxes of mandatory testing 1, mandatory testing 2, and optional testing 3, the GUI module may determine that the user has selected mandatory testing 1, mandatory testing 2 and optional testing 3, and may then collect the testing profile ID of mandatory testing 1, the testing profile ID of mandatory testing 2, and the testing profile ID of optional testing 3.

At operation 1040, the collected testing information is outputted. Specifically, the GUI module may be configured to output the collected testing information to another module (e.g., automation module 530, etc.). For instance, the GUI module may be configured to provide (e.g., in a compiled document, in a list, in a computer readable instruction, etc.) the collected testing profile ID to said another module.

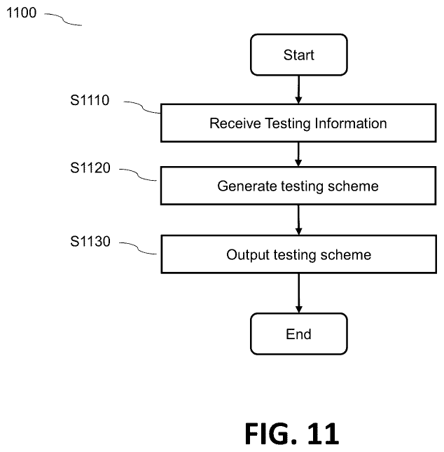

FIG. 11 illustrates an example flow diagram of a method 1100 for generating a testing scheme, according to one or more embodiments. Method 1100 may be performed by automation module 530 in FIG. 5.

Referring to FIG. 11, at operation S1110, testing information is received. Specifically, an automation module (e.g., module 530) may be configured to receive testing information from another module (e.g., GUI module 520). The testing information may correspond to the collected testing information provided at operation S1040 in FIG. 10.

At operation S1120, a testing scheme is generated. Specifically, the automation module may be configured to generate the testing scheme based on the received testing information. For instance, the automation module may obtain (from a testing module or any suitable storage medium) testing information (e.g., testing type, testing priority level, testing urgency level, etc.) based on the testing profile ID, may configure or arrange how specifically the testing should be executed (e.g., which testing should be executed first, which testing variable should be adjusted, etc.), and may then generate the testing scheme which defines or specifies how specifically the testing should be executed.

By way of example, assuming that the received testing information comprises testing profile IDs of mandatory testing 1, mandatory testing 2, and optional testing 3, the automation module may request a testing module (e.g., module 540) for the corresponding testing profile based on the respective testing profile ID. Accordingly, the automation module may be configured to receive testing profile of mandatory testing 1 (which defines testing workflows and pipelines of mandatory testing 1) and testing profile of mandatory testing 2 (which defines testing workflows and pipelines of mandatory testing 2) from mandatory testing module (e.g., mandatory testing module 541) of the testing module, and to receive testing profile of optional testing 3 (which defines testing workflows and pipelines of optional testing 3) from optional testing module (e.g., optional testing module 542) of the testing module.

Subsequently, the automation module may be configured to arrange the sequence of testing based on the testing category and/or the testing priority. For instance, the automation module may determine that mandatory testing (i.e., mandatory testing 1 and mandatory testing 2) should be executed before optional testing (i.e., optional testing 3), and may further determine that mandatory testing with higher priority (e.g., higher urgency, more critical to system stability or security, consume less resources, etc.) should be executed first. Assuming that mandatory testing 1 has a higher testing priority than mandatory testing 2, the automation module may determine that the three testing selected by the user should be executed in the following sequence: execute mandatory testing 1 first, following by mandatory testing 2, and then optional testing 3. It is contemplated that the above are merely examples of possible embodiments, and the testing may also be arranged in different manner (e.g., mandatory testing 1 and mandatory 2 execute simultaneously, optional testing 3 should be firstly executed under certain conditions, etc.) without departing from the scope of the present disclosure.

At operation S1130, the testing scheme is outputted. Specifically, the automation module may be configured to provide the generated testing scheme to another module (e.g., a testing module, etc.).

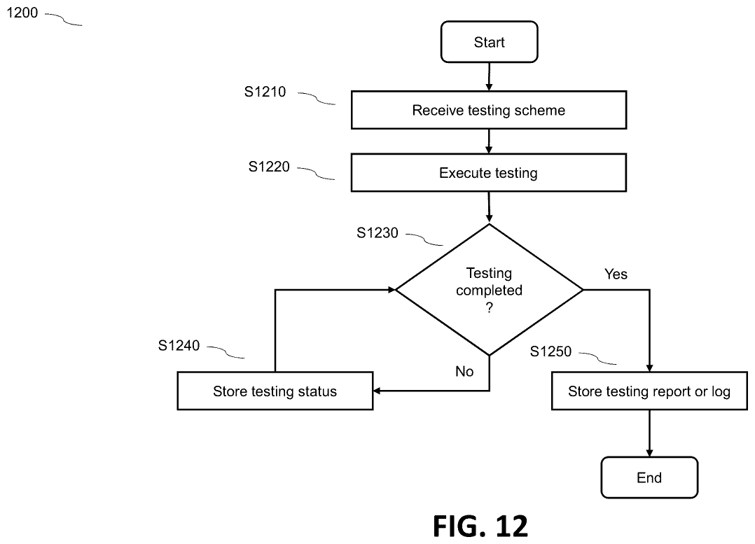

FIG. 12 illustrates an example flow diagram of a method 1200 for managing one or more testing, according to one or more embodiments. Method 1200 may be performed by testing module 310 of FIG. 3 or testing module 540 in FIG. 5.

Referring to FIG. 12, at operation S1210, a testing scheme is received. Specifically a testing module may be configured to receive a testing scheme from another module (e.g., automation module 530). The received testing scheme may correspond to testing scheme provided by the automation module at operation S1130 in FIG. 11.

At operation S1220, one or more testing are executed. Specifically, the testing module may be configured to execute the testing based on the received testing scheme. By way of example, based on determining (from the testing scheme) that mandatory testing 1 should be execute first, following by mandatory testing 2, and then optional testing 3, the testing module (or the mandatory testing module and the optional testing module included therein) may be configured to schedule, to execute, and to record said testing according to the configuration and setting defined in the testing scheme.

At operation S1230, status of one or more testing is determined. Specifically, the testing module may be configured to determine whether or not any of the one or more testing has been completed. Based on determining that a testing has been completed, the process proceed to operation S1250. Alternatively, based on determining that a testing has not been completed, the process proceeds to operation S1240.

At operation S1240, the status of a testing (e.g., pending, completed, failed, elapsed time, etc.) is stored. Specifically, the testing module (or the respective sub-module, such as mandatory testing module and optional testing module) may be configured to monitor the status of each testing, and may be configured to continuously or periodically store the status information in a storage module (e.g., storage module 550).

On the other hand, at operation S1250, the testing report or log are stored. Specifically, the testing module (or the respective sub-module, such as mandatory testing module and optional testing module) may be configured to generate or update a report or log for each executed testing, and may be configured to store the report or log in the storage module upon detecting that the associated testing is ended (e.g., completed, failed, dismissed, etc.).

In an example embodiment, the testing module may be configured to store the testing status in a first storage of storage module and to store the testing report or log in a second storage of storage module. Further, it can be understood that operation S1240 and operation S1250 may be performed simultaneously. By way of example, assuming that multiple testing (e.g., mandatory testing 1 and mandatory testing 2) are being executed simultaneously, based on determining that mandatory testing 1 has been completed but mandatory testing 2 has not been completed, the testing module may be configured to store the testing status of mandatory testing 2in the first storage of the storage module and to store the testing reports/logs of mandatory testing 1 in the second storage of the storage module.

In view of the above, example embodiments of the present disclosure provide a system and method that efficiently and effectively setting up or configuring one or more testing for a user. Specifically the system and method of the example embodiments allow the user to configure or customize one or more testing at user end as per requirement, and the one or more customized testing may be automatically performed. Thus, multiple to-and-fro communications among multiple parties in configuring a testing in the related art may be eliminated, and the associated processes may be simplified. Accordingly example embodiments of the present disclosure effectively reduce the burden of the users (e.g., the testing requestor and the testing party), improve the efficiency in process of testing customization, and simplify the process of testing execution.

Further, example embodiments of the present disclosures provide a system and method that efficiently and effectively manage testing information such as testing status and/or testing result/log. Specifically, the system and method of the example embodiments automatically generate and provide the testing status and/or testing results to the user as per request, such as provide the testing status and/or testing results in real-time or near real-time and provide the testing status and/or testing results associated with multiple testing in a converged manner, without the involvement of the testing party. Accordingly, the testing status and/or testing results can be provided in a timely and effective manner.

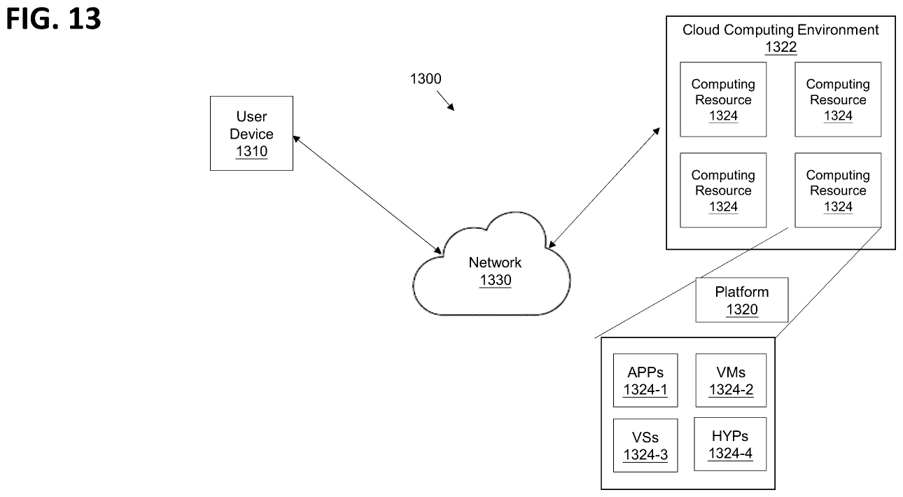

FIG. 13 is a diagram of an example environment 1300 in which systems and/or methods, described herein, may be implemented. As shown in FIG. 13, environment 1300 may include a user device 1410, a platform 1420, and a network 1330. Devices of environment 1300 may interconnect via wired connections, wireless connections, or a combination of wired and wireless connections. In embodiments, any of the functions and operations described with reference to FIGS. 1 through 12 above may be performed by any combination of elements illustrated in FIG. 13.

User device 1310 includes one or more devices capable of receiving, generating, storing, processing, and/or providing information associated with platform 1320. For example, user device 1310 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 1310 may receive information from and/or transmit information to platform 1320.

Platform 1320 includes one or more devices capable of receiving, generating, storing, processing, and/or providing information. In some implementations, platform 1320 may include a cloud server or a group of cloud servers. In some implementations, platform 1320 may be designed to be modular such that certain software components may be swapped in or out depending on a particular need. As such, platform 1320 may be easily and/or quickly reconfigured for different uses.

In some implementations, as shown, platform 1320 may be hosted in cloud computing environment 1322. Notably, while implementations described herein describe platform 1320 as being hosted in cloud computing environment 1322, in some implementations, platform 1320 may not be cloud-based (i.e., may be implemented outside of a cloud computing environment) or may be partially cloud-based.

Cloud computing environment 1322 includes an environment that hosts platform 1320. Cloud computing environment 1322 may provide computation, software, data access, storage, etc., services that do not require end-user (e.g., user device 1310) knowledge of a physical location and configuration of system(s) and/or device(s) that hosts platform 1320. As shown, cloud computing environment 1322 may include a group of computing resources 1324 (referred to collectively as “computing resources 1324” and individually as “computing resource 1324”).

Computing resource 1324 includes one or more personal computers, a cluster of computing devices, workstation computers, server devices, or other types of computation and/or communication devices. In some implementations, computing resource 1324 may host platform 1320. The cloud resources may include compute instances executing in computing resource 1324, storage devices provided in computing resource 1324, data transfer devices provided by computing resource 1324, etc. In some implementations, computing resource 1324 may communicate with other computing resources 1324 via wired connections, wireless connections, or a combination of wired and wireless connections.

As further shown in FIG. 13, computing resource 1324 includes a group of cloud resources, such as one or more applications (“APPs”) 1324-1, one or more virtual machines (“VMs”) 1324-2, virtualized storage (“VSs”) 1324-3, one or more hypervisors (“HYPs”) 1324-4, or the like.

Application 1324-1 includes one or more software applications that may be provided to or accessed by user device 1310. Application 1324-1 may eliminate a need to install and execute the software applications on user device 1310. For example, application 1324-1 may include software associated with platform 1320 and/or any other software capable of being provided via cloud computing environment 1322. In some implementations, one application 1324-1 may send/receive information to/from one or more other applications 1324-1, via virtual machine 1324-2.

Virtual machine 1324-2 includes a software implementation of a machine (e.g., a computer) that executes programs like a physical machine. Virtual machine 1324-2 may be either a system virtual machine or a process virtual machine, depending upon use and degree of correspondence to any real machine by virtual machine 1324-2. A system virtual machine may provide a complete system platform that supports execution of a complete operating system (“OS”). A process virtual machine may execute a single program, and may support a single process. In some implementations, virtual machine 1324-2 may execute on behalf of a user (e.g., user device 1310), and may manage infrastructure of cloud computing environment 1322, such as data management, synchronization, or long-duration data transfers.

Virtualized storage 1324-3 includes one or more storage systems and/or one or more devices that use virtualization techniques within the storage systems or devices of computing resource 1324. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 1324-4 may provide hardware virtualization techniques that allow multiple operating systems (e.g., “guest operating systems”) to execute concurrently on a host computer, such as computing resource 1324. Hypervisor 1324-4 may present a virtual operating platform to the guest operating systems, and may manage the execution of the guest operating systems. Multiple instances of a variety of operating systems may share virtualized hardware resources.

Network 1330 includes one or more wired and/or wireless networks. For example, network 1330 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 13 are provided as an example. In practice, there may be additional devices and/or networks, fewer devices and/or networks, different devices and/or networks, or differently arranged devices and/or networks than those shown in FIG. 13. Furthermore, two or more devices shown in FIG. 13 may be implemented within a single device, or a single device shown in FIG. 13 may be implemented as multiple, distributed devices. Additionally, or alternatively, a set of devices (e.g., one or more devices) of environment 1300 may perform one or more functions described as being performed by another set of devices of environment 1300.

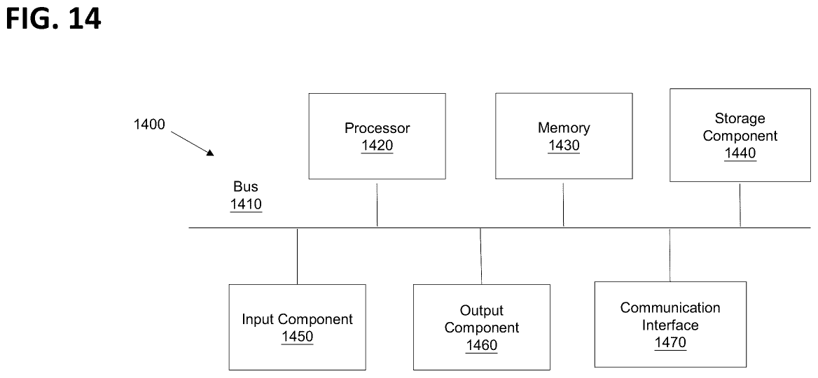

FIG. 14 is a diagram of example components of a device 1400. Device 1400 may correspond to user device 1310 and/or platform 1320 in FIG. 13. As shown in FIG. 14, device 1400 may include a bus 1410, a processor 1420, a memory 1430, a storage component 1440, an input component 1450, an output component 1460, and a communication interface 1470.

Bus 1410 includes a component that permits communication among the components of device 1400. Processor 1420 may be implemented in hardware, firmware, or a combination of hardware and software. Processor 1420 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 1420 includes one or more processors capable of being programmed to perform a function. Memory 1430 includes a random access memory (RAM), a read only memory (ROM), and/or another type of dynamic or static storage device (e.g., a flash memory, a magnetic memory, and/or an optical memory) that stores information and/or instructions for use by processor 1420.

Storage component 1440 stores information and/or software related to the operation and use of device 1400. For example, storage component 1440 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 1450 includes a component that permits device 1400 to receive information, such as via user input (e.g., a touch screen display, a keyboard, a keypad, a mouse, a button, a switch, and/or a microphone). Additionally, or alternatively, input component 1450 may include a sensor for sensing information (e.g., a global positioning system (GPS) component, an accelerometer, a gyroscope, and/or an actuator). Output component 1460 includes a component that provides output information from device 1400 (e.g., a display, a speaker, and/or one or more light-emitting diodes (LEDs)).

Communication interface 1470 includes a transceiver-like component (e.g., a transceiver and/or a separate receiver and transmitter) that enables device 1400 to communicate with other devices, such as via a wired connection, a wireless connection, or a combination of wired and wireless connections. Communication interface 1470 may permit device 1400 to receive information from another device and/or provide information to another device. For example, communication interface 1470 may include an Ethernet interface, an optical interface, a coaxial interface, an infrared interface, a radio frequency (RF) interface, a universal serial bus (USB) interface, a Wi-Fi interface, a cellular network interface, or the like.

Device 1400 may perform one or more processes described herein. Device 1400 may perform these processes in response to processor 1420 executing software instructions stored by a non-transitory computer-readable medium, such as memory 1430 and/or storage component 1440. A computer-readable medium is defined herein as a non-transitory memory device. A memory device includes memory space within a single physical storage device or memory space spread across multiple physical storage devices.

Software instructions may be read into memory 1430 and/or storage component 1440 from another computer-readable medium or from another device via communication interface 1470. When executed, software instructions stored in memory 1430 and/or storage component 1440 may cause processor 1420 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 14 are provided as an example. In practice, device 1400 may include additional components, fewer components, different components, or differently arranged components than those shown in FIG. 14. Additionally, or alternatively, a set of components (e.g., one or more components) of device 1400 may perform one or more functions described as being performed by another set of components of device 1400.

In embodiments, any one of the operations or processes of FIGS. 1 through 12 may be implemented by or using any one of the elements illustrated in FIGS. 13 and 14.

Example embodiments of the present disclosure provide a method and system in which enrollment and onboarding processes of network services, as opposed to manually onboarding network services on-site, are simplified and automated. The centralized enrollment and onboarding processes can save time and resources, and, in particular, the automation minimizes human errors and compatibility failures and improves customer satisfaction and reduces business risks for users (e.g., service providers), among other benefits. Further, by automating the enrollment and onboarding of users (e.g., service providers) in a centralized and guided manner, the online marketplace platform provides customers (e.g., network operators) with a simple, flexible, cost-effective, efficient, and rapidly implementable solution for network service selection. For the user (e.g., service providers), the enrollment and onboarding process of network services provides a low-risk test environment with minimal impact on the customer (e.g., network operators) to provide high-quality service without burdening customers with a high volume of requests.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer-readable medium at any possible technical detail level of integration. Further, one or more of the above components described above may be implemented as instructions stored on a computer readable medium and executable by at least one processor (and/or may include at least one processor). The computer-readable medium may include a computer-readable non-transitory storage medium (or media) having computer-readable program instructions thereon for causing a processor to carry out operations.

The computer readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming languages such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or another device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A system comprising:
a first module comprising:
a memory storage storing computer-executable instructions; and
a processor communicatively coupled to the memory storage, wherein the processor is configured to execute the computer-executable instructions and cause the first module to:
present, to a user, information of one or more testing associated to a service, wherein the one or more testing comprise at least one mandatory testing and at least one optional testing;
receive, from the user, a selection for the one or more testing;
collect testing information associated with the user's selection; and
output the collected testing information.

2. The system as claimed in claim 1, wherein:
the processor of the first module is configured to execute the computer-executable instructions and cause the first module to generate a graphical user interface (GUI) and to present the information of the one or more testing via the GUI.

3. The system as claimed in claim 2, wherein the GUI comprises one or more interactive elements which are associated with the one or more testing; and wherein the processor of the first module is configured to execute the computer-executable instructions and cause the first module to receive the user's selection by determining one or more user's interaction on the one or more interactive elements.

4. The system as claimed in claim 3, wherein the one or more interactive elements are associated with a testing profile ID; and wherein the processor of the first module is configured to execute the computer-executable instructions and cause the first module to collect the testing information associated with the user's selection by collecting testing profile ID of user's selected testing.

5. The system as claimed in claim 1, further comprising:
a second module comprising:
a memory storage storing computer-executable instructions; and
a processor communicatively coupled to the memory storage, wherein the processor is configured to execute the computer-executable instructions and cause the second module to:
receive, from the first module, the collected testing information;
generate, based on the collected testing information, a testing scheme; and
output the generated testing scheme.

6. The system as claimed in claim 5, further comprising:
a third module comprising:
a memory storage storing computer-executable instructions; and
a processor communicatively coupled to the memory storage, wherein the processor is configured to execute the computer-executable instructions and cause the third module to:
receive, from the second module, the generated testing scheme;
execute, based on the testing scheme, the one or more testing selected by the user; and
store information associated with the testing.

7. The system as claimed in claim 6, further comprising:
a fourth module comprising
a memory storage storing computer-executable instructions; and
a processor communicatively coupled to the memory storage, wherein the processor is configured to execute the computer-executable instructions and cause the fourth module to:
receive, from the third module, the information associated with the testing;
store the received information; and
provide the stored information to the first module.

8. A method, performed by at least one processor, comprising:
presenting, by a first module, information of one or more testing associated to a service to a user, wherein the one or more testing comprise at least one mandatory testing and at least one optional testing;
receiving, by the first module, a selection for the one or more testing from the user;
collecting, by the first module, testing information associated with the user's selection; and
outputting, by the first module, the collected testing information.

9. The method as claimed in claim 8, wherein the presenting of the information of the one or more testing comprises:
generating, by the first module, a graphical user interface (GUI); and
presenting, by the first module, the information of the one or more testing via the GUI.

10. The method as claimed in claim 9, wherein the GUI comprises one or more interactive elements which are associated with the one or more testing; and wherein the receiving of the user's selection comprises determining, by the first module, one or more user's interaction on the one or more interactive elements.

11. The method as claimed in claim 10, wherein the one or more interactive elements are associated with a testing profile ID; and wherein the collecting of the testing information associated with the user's selection comprises collecting, by the first module, testing profile ID of user's selected testing.

12. The method as claimed in claim 8, further comprising:
receiving, by a second module, the collected testing information from the first module;
generating, by the second module, a testing scheme based on the collected testing information; and
outputting, by the second module, the generated testing scheme.

13. The method as claimed in claim 12, further comprising:
receiving, by a third module, the generated testing scheme from the second module;
executing, by the third module, the one or more testing selected by the user based on the testing scheme; and
storing, by the third module, information associated with the testing.

14. The method as claimed in claim 13, further comprising:
receiving, by a fourth module, the information associated with the testing from the third module;
storing, by the fourth module, the received information; and
providing, by the fourth module, the stored information to the first module.

15. A non-transitory computer-readable recording medium having recorded thereon instructions executable by a processor to cause the processor to perform a method comprising:
presenting, by a first module, information of one or more testing associated to a service to a user, wherein the one or more testing comprise at least one mandatory testing and at least one optional testing;
receiving, by the first module, a selection for the one or more testing from the user;
collecting, by the first module, testing information associated with the user's selection; and
outputting, by the first module, the collected testing information.

16. The non-transitory computer-readable recording medium as claimed in claim 15, wherein the presenting of the information of the one or more testing comprises:
generating, by the first module, a graphical user interface (GUI); and
presenting, by the first module, the information of the one or more testing via the GUI.

17. The non-transitory computer-readable recording medium as claimed in claim 16, wherein the GUI comprises one or more interactive elements which are associated with the one or more testing; and wherein the receiving of the user's selection comprises determining, by the first module, one or more user's interaction on the one or more interactive elements.

18. The non-transitory computer-readable recording medium as claimed in claim 17, wherein the one or more interactive elements are associated with a testing profile ID; and wherein the collecting of the testing information associated with the user's selection comprises collecting, by the first module, testing profile ID of user's selected testing.

19. The non-transitory computer-readable recording medium as claimed in claim 15, wherein the method further comprising:
receiving, by a second module, the collected testing information from the first module;
generating, by the second module, a testing scheme based on the collected testing information; and
outputting, by the second module, the generated testing scheme.

20. The non-transitory computer-readable recording medium as claimed in claim 19, wherein the method further comprising:
receiving, by a third module, the generated testing scheme from the second module;
executing, by the third module, the one or more testing selected by the user based on the testing scheme; and
storing, by the third module, information associated with the testing.
